(19) United States
(12) Patent Application Publication
(10) Pub. No.: US 2003/0023695 A1
(43) Pub. Date: Jan. 30, 2003

(54) Modifying an electronic mail system to produce a secure delivery system

(75) Inventors: Hiroshi Kobata, Brookline, MA (US); Robert Gagne, Boston, MA (US)

Correspondence Address: JOHN F. HAYDEN, Fish & Richardson P.C., 11th Floor, 1425 K Street, N.W., Washington, DC, 20005-3500, US

(73) Assignee: Atabok Japan, Inc.

(21) Appl. No.: 10/141,771

(22) Filed: May 10, 2002

Related U.S. Application Data
(63) Continuation-in-part of application No. 09/258,609, filed on Feb. 26, 1999.
(63) Continuation-in-part of application No. 09/334,309, filed on Jun. 16, 1999.
(60) Provisional application No. 60/289,791, filed on May 10, 2001.

(51) Int. Cl. G06F 15/16

(52) U.S. Cl. 709/206

(57) ABSTRACT

An electronic mail system is modified to produce a secure delivery system by modifying a user interface of the electronic mail system to present a secure delivery icon and causing the electronic mail system to initiate a secure delivery in response to actuation of the secure delivery icon. The secure delivery uses a delivery protocol different from a protocol provided by the electronic mail system, and the secure delivery icon is presented in addition to a normal delivery icon of the electronic mail system.

### CROSS-REFERENCE TO RELATED APPLICATIONS

This application claims the benefit of U.S. Application Ser. No. 09/258,609, titled “Electronic Parcel Delivery System” and filed Feb. 26, 1999, U.S. Application Ser. No. 09/334,309, titled “Electronic Parcel Delivery System” and filed Jun. 16, 1999, and U.S. Provisional Application No. 60/289,791, titled “Hybrid Electronic Mail and Electronic Parcel Delivery System” and filed May 10, 2001, all of which are incorporated by reference.

### TECHNICAL FIELD

The invention relates to modifying an electronic mail system to produce a secure delivery system.

### BACKGROUND

The Internet is an international collection of interconnected networks currently providing connectivity among millions of computer systems. One part of the Internet is the World Wide Web (“Web”), a graphics and sound-oriented technology used by computer systems to access a vast variety of digital information, such as files, documents, images, and sounds, stored on other computer systems, called “Web sites” (or “Web servers”). A Web site includes electronic pages or documents called “Web pages”.

Computer system users can view digital information at Web sites through a graphical user interface (GUI) produced by executing client software called a “browser”. Examples of commercially available Web browsers include NETSCAPE NAVIGATOR™ and MICROSOFT EXPLORER™. Web browsers use a variety of standardized methods (i.e., protocols) for addressing and communicating with Web servers. A common protocol for publishing and viewing linked text documents is HyperText Transfer Protocol (HTTP).

To access a Web page at a Web server, a computer system user enters the address of the Web page, called a Uniform Resource Locator (URL), in an address box provided by the Web browser. The URL can specify the location of a Web server or a file on a Web server. An accessed Web page can include any combination of text, graphics, audio, and video information (e.g., images, motion pictures, or animation). Often, the accessed Web page has links, called hyperlinks, to documents at other Web pages on the Web. Also, an accessed Web page can invoke execution of an application program.

The development of the Web has enabled computer users to exchange messages and documents both locally and across the world. One popular form of network communication among Web users is electronic mail (e-mail). Most e-mail communication between users is in the form of short messages. Occasionally, an e-mail message may have an attachment, which is a file that is transmitted with the message. This file can be in one of many formats, such as text, graphics, or executable software. E-mail systems, however, often limit the size of e-mail messages, and require attachments exceeding the designated size limit to be broken into smaller files and reconstructed by the recipient, a task that is inconvenient and may be beyond the capabilities of many e-mail users. Consequently, e-mail may not be a practical medium for transmitting formatted documents, which frequently are large in size and may exceed size limits of e-mail systems . Other protocols, such as HTTP and FTP (file-transfer protocol), are able to transfer large files, but interruptions on the network can require repeated transfer attempts to successfully transfer a complete file.

The problem of delivering large documents across the network has led to the development of electronic document delivery systems. One known electronic document delivery system includes a server interposed between sending and receiving computers. The sending system transmits the document to the server, and the server transmits a notification to the receiving system after receiving the full document. This notification includes a direct reference to the document stored on the server. The receiving system uses the direct reference to locate and download the document from the server.

### SUMMARY

In one general aspect, an electronic mail system is modified to produce a secure delivery system by modifying a user interface of the electronic mail system to present a secure delivery icon and causing the electronic mail system to initiate a secure delivery in response to actuation of the secure delivery icon. The secure delivery uses a delivery protocol different from a protocol provided by the electronic mail system, and the secure delivery icon is presented in addition to a normal delivery icon of the electronic mail system.

Implementations may include one or more of the following features. For example, after actuation of the secure delivery icon, an indication that a message was delivered using secure delivery may be inserted in a subject line associated with the message. Similarly, a message delivered using secure delivery may be associated with an icon indicating that the message was delivered using secure delivery. For example, a padlock icon may be superimposed on a portion of a normal message icon used by the electronic mail system.

Causing the electronic mail system to initiate a secure delivery may include encrypting, digital content at a sending system, to produce encrypted digital content, and transmitting the encrypted digital content over a secured communication path from the sending system to a receiving system. The encrypted digital content may be compressed before transmission.

A preview pane of the electronic mail system at a receiving system may be prevented from displaying any portion of digital content sent by the secure delivery. In addition, a security message may be presented to alert a recipient that the digital content sent by the secure delivery cannot be displayed in the preview pane and, instead, must be opened to be viewed.

The user interface of the electronic mail system may be further modified to present an autoshred icon before or during the secure delivery. Actuation at a sending side of the autoshred icon may cause digital content sent by the secure delivery to be erased from a receiving system after a recipient has manipulated the digital content a controllable number of times. Actuation of the autoshred icon also may cause a graphical manipulation of a screen display of the digital content, such that the screen display appears to shred and disappear.

A popup window displayed at the receiving side may describe how digital content sent by the secure delivery may be manipulated by a recipient once a recipient chooses to open the digital content.

The user interface of the electronic mail system may be modified to present a secure delivery icon that provides a sender with a clear visual option to send digital content using a secure digital rights management delivery system or an unsecure delivery system.

The user interface of the electronic mail system may be further modified to present a recall icon before or during the secure delivery. Actuation at a sending side of the recall icon may cause digital content sent by the secure delivery to be automatically recalled and erased from a receiving system, or may prevent digital content sent by the secure delivery from being manipulated in any way.

The user interface of the electronic mail system may be further modified to present a prevent chain letter icon before or during the secure delivery. Actuation at a sending side of the prevent chain letter icon may prevent digital content sent by the secure delivery from being forwarded to any other receiving system.

The user interface of the electronic mail system may be further modified to present a prevent copy icon before or during the secure delivery. Actuation at a sending side of the prevent copy icon may prevent digital content sent by the secure delivery from being copied in any manner.

The user interface of the electronic mail system may be further modified to present tracking options before or during the secure delivery. Actuation at a sending side of the prevent copy icon may cause tracking of usage of digital content sent by the secure delivery to a receiving system. This tracking of usage may include gathering information about at least one of a time the digital content was received, a time the digital content was viewed, if the digital content was viewed, and how the digital content was manipulated.

The electronic mail system may be, for example, Microsoft® Outlook® or Lotus® Notes.

Other features and advantages will be apparent from the description, including the drawings, and from the claims.

### DESCRIPTION OF DRAWINGS

FIG. 1 is a diagram of an electronic parcel delivery system including a sending system in communication with a receiving system through a server system.

FIG. 2 is a diagram of a delivery system in which the sending system transmits a parcel to the server system and a notification to the receiving system.

FIG. 3. is a diagram of graphical windows presented to the receiving system when accessing the parcel stored on the server system.

FIG. 4 is a diagram of a delivery system in which the sending system communicates with a Web server, using a Web browser, to send the notification to the receiving system.

FIG. 5 is a diagram of a delivery system in which the sending system communicates with a Web server, using a Web browser, to send the notification to the receiving system and the parcel to the server system.

FIG. 6 is a diagram of a delivery system in which the sending system communicates with a Web server using client software to send the notification to the receiving system, and the receiving system communicates with the server system using client software to obtain the parcel.

FIG. 7 is a diagram of a delivery system in which the sending system delivers the parcel to the receiving system without notifying the receiving system that a parcel has been transmitted.

FIG. 8 is a diagram of a group of servers acting logically as the server system of the delivery system of FIG. 1.

FIG. 9 is a diagram of the electronic parcel delivery system in which proxy servers separate the sending and receiving systems from the network.

FIG. 10 illustrates a format and content of an HTTP transaction used to transmit a parcel through an HTTP proxy server.

FIG. 11A is a flow chart of a procedure by which the sending system transmits a parcel to the server system.

FIG. 11B is a flow chart of a procedure by which the sending system or the receiving system obtains approval from the server system to upload or download a parcel.

FIG. 11C is a flow chart of a procedure by which the sending system prepares and transmits a parcel portion to the server system, and the server system prepares and transmits the parcel portion to the receiving system.

FIG. 12 is a flow chart of a procedure that dynamically determines the byte size of a transaction for transmitting a parcel portion.

FIG. 13 is a flow chart of a procedure by which a system transmitting the parcel dynamically determines the format of information encapsulated within a meta-protocol transaction.

FIG. 14 is a diagram of an electronic parcel delivery system used to conduct electronic commerce.

FIG. 15A is a diagram of an electronic parcel delivery system used for coordinating order and receipt of goods among various entities.

FIG. 15B is a flow chart of a procedure performed by the electronic parcel delivery system of FIG. 15A.

FIG. 16A is a diagram illustrating communications between different system entities.

FIG. 16B is a flow chart illustrating a procedure by which the system of FIG. 16A coordinates work flow activities among the different system entities.

FIG. 17 is a block diagram of a hybrid system that integrates an electronic mail system with an electronic parcel delivery system.

FIG. 18A is a flow chart of a procedure implemented by the system of FIG. 17.

FIGS. 18B and 18C are flow diagrams of processes used to send (FIG. 18B) and receive electronic mail messages and parcels implementation.

FIG. 19 is a block diagram of another hybrid system that integrates an electronic mail system with an electronic parcel delivery system.

FIG. 20A is a block diagram of an exemplary virtual private network and a flowchart describing its operation, respectively.

FIG. 20B is a flow chart of a process for operating the virtual private network of FIG. 20A.

FIG. 21 is a block diagram of another exemplary virtual private network.

FIGS. 22A-22D illustrate exemplary graphical user interfaces used in enabling a receiving and sending automation module.

FIG. 23 is a flow chart of a process for converting a standard e-mail system to a hybrid system implementation.

FIG. 24 is a block diagram showing a relationship between an existing software application and a plug-in application.

FIGS. 25-39 are screen displays of software applications including a plug-in application.

### DETAILED DESCRIPTION

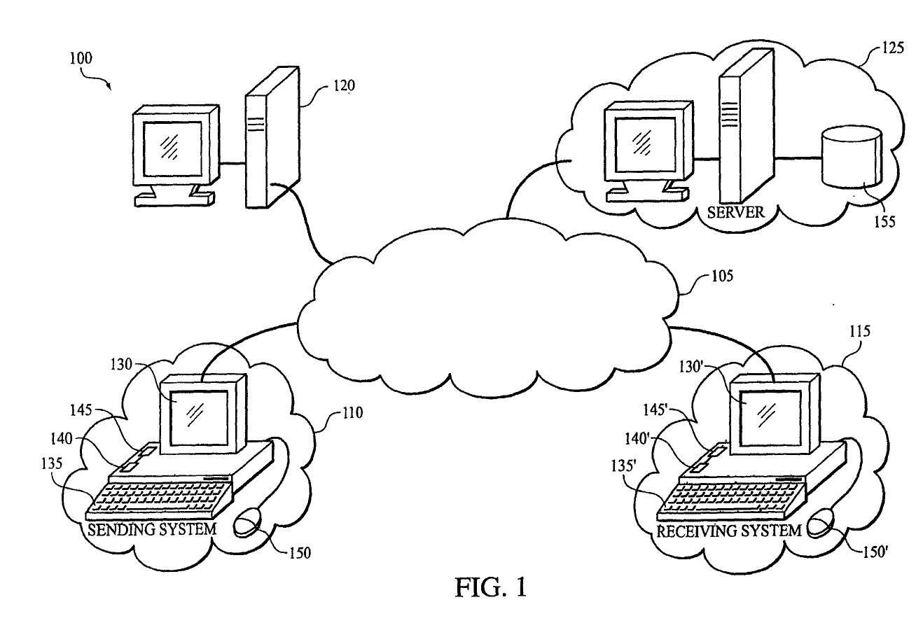

A hybrid electronic mail and electronic parcel delivery system combines features of an electronic mail (e-mail) system with those of an electronic parcel delivery system. For illustrative purposes, an electronic parcel delivery system is discussed with reference to FIGS. 1-16B prior to the discussion of the hybrid system.

Electronic Parcel Delivery System

Referring to FIG. 1, an electronic parcel delivery system 100 may be used to deliver files electronically over a network 105. The system may deliver files of any size or type, such as, for example, binary digital information, text, documents, parcels, multimedia content, video, audio, digital images, software, source code and folders. The parcel delivery system 100 includes a sending computer system 110, a receiving computer system 115, and server systems 120 and 125 connected to the network 105. It is to be understood that more than one sending system and more than one receiving system may be connected to the network 105. The network 105 can be, for example, a local-area network (LAN), a wide area network (WAN), such as the Internet or the World Wide Web, or any other suitable network configuration.

Each of the sending, receiving, and server systems can be connected to the network 105 through a variety of connections including, for example, standard telephone lines, LAN or WAN links (e.g., T1, T3, 56 kb, or X.25), broadband connections (e.g., ISDN, Frame Relay, or ATM), and wireless connections. The connections can be established using a variety of communication protocols (e.g., HTTP, TCP/IP, IPX, SPX, NetBIOS, Ethernet, RS232, or direct asynchronous connections).

Each of the sending and receiving systems 110, 115 can be any personal computer, thin-client device, Windows-based terminal, Network Computer, wireless device, information appliance, workstation, mini computer, main frame computer, or other computing device having a graphical user interface. Windows-oriented platforms supported by the sending and receiving systems 110, 115 can include Windows 3.x, Windows 95, Windows 98, Windows 2000, Windows XD, Windows NT 3.51, Windows NT 4.0, Windows CE, Windows CE for Windows Based Terminals, Macintosh, Java, and Unix. Each of the sending and receiving systems 110 and 115 can include a display screen 130 or 130′, a keyboard 135 or 135′, memory 140 or 140′, a processor 145 or 145′, and a mouse 150 or 150′, respectively.

Each server system 120 or 125 can be any computing system able to operate as a Web server, to communicate according to the HTTP protocol, to maintain Web pages, to process URLs, and to control access to other portions of the network 105 (e.g., workstations, storage systems, or printers) or to other networks. The server system 120 can also operate as an email server for exchanging e-mail messages between the sending system 110 and receiving system 115.

The server system 125 includes a storage device 155 for storing digital information received from sending systems and destined for subsequent transmission to receiving systems. The storage device 155 can be persistent storage, such as a hard-drive device, or volatile storage, such as dynamic RAM.

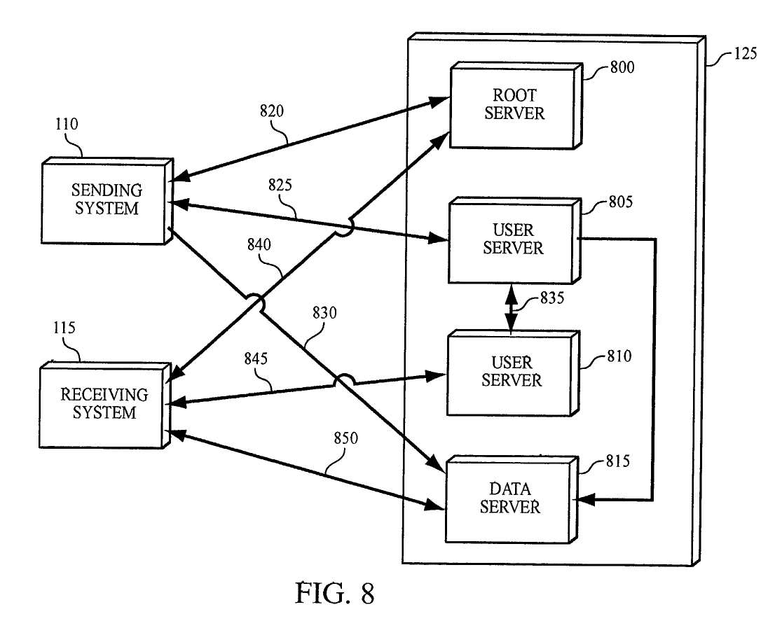

Each of the server systems 120 and 125 can include a group of server computer systems logically acting as a single server system and organized in a scalable architecture (see FIG. 8). The server systems 120 and 125 provide electronic parcel delivery service between the sending and receiving systems. Application software installed on the sending system 110 (referred to as client parcel software) and on the server system 125 (referred to as parcel server software) performs the parcel delivery service functions. The client parcel software can be installed on receiving system 115, although this is not necessary for the receiving system to receive parcels. Upon installation, the client parcel software collects proxy and protocol information from the configurations of Web browsers installed on the sending system 110 or the receiving system 115. This information indicates whether a proxy is necessary to transmit parcels onto the network 105 and the necessary protocol (e.g., HTTP) to use. According to this collected information, the client parcel software automatically configures the proxy and sets the protocol in the configuration files on the sending system 110 or the receiving system 115. If the client parcel software determines that the sending system 110 does not have any installed Web browsers, then the proxy and protocol remain set at default values, namely “no proxy” and “TCP/IP,” respectively.

When launched, the client parcel software communicates with the server parcel software. The client parcel software provides the functionality for sending and receiving parcels. Consequently, the roles of the sending and receiving systems 110 and 115 can reverse, with the sending system 110 becoming a receiver and the receiving system 115 becoming a sender.. The server system 125 operates as a warehouse for received, but undelivered parcels.

The parcel delivery service provides senders and receivers a variety of services. These services are described below and include data streaming, transmission interruptibility, data encryption and compression, parcel tracking, and parcel canceling. The sending and receiving systems 110 and 115 can employ at least two techniques for accessing the parcel delivery service: (1) by executing the client parcel software; and (2) by executing a Web browser, e.g., NETSCAPE NAVIGATOR™ or MICROSOFT INTERNET EXPLORER™. Executing the client parcel software brings the senders and receivers into communication with the server parcel software executing on the server system 125, while executing the browser brings the senders and receivers to a common-entry Web page (e.g., a home page) on the server system 125.

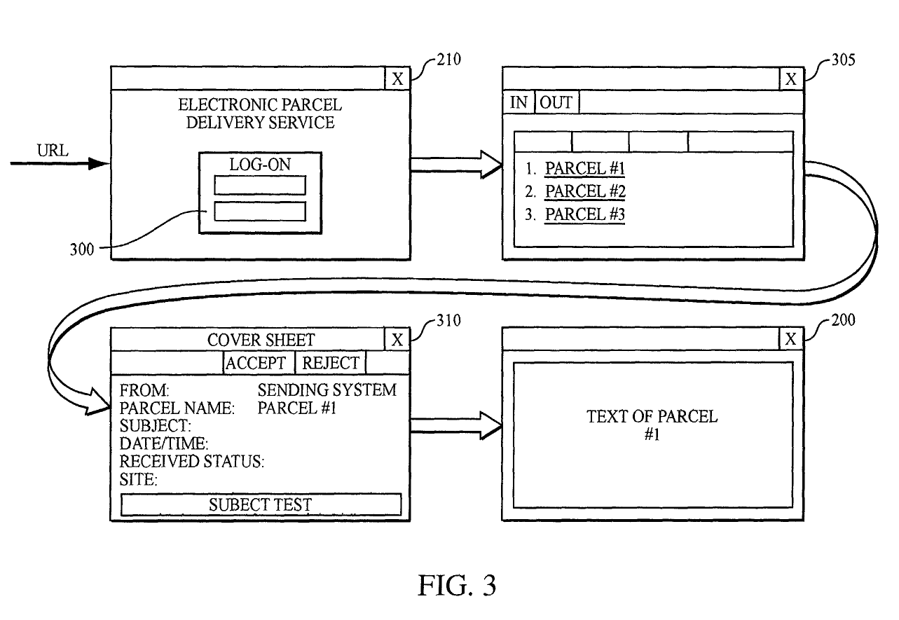

Upon accessing the server system 125, the senders and the receivers are presented with a variety of graphical windows through which they can perform the desired parcel sending and receiving operations. These windows are described below in connection with FIG. 3. Although described with respect to Web pages and graphical windows, the system is not limited to the context of the World Wide Web, Web pages, and graphical windows. For example, senders and receivers can operate in a non-graphical environment, entering command line operations according to protocols, such as the file transfer protocol, to send parcels to and obtain file directories from the server system 125.

To start the parcel delivery service through the client parcel software, the senders and receivers can double-click with a mouse on a graphical, desktop icon representing the client parcel software. An alternative method for sending a parcel is to drag-and-drop a graphical representation of that parcel onto the icon. To start the parcel delivery service using the Web browser, users of the sending and receiving systems 110 and 115 can double-click on a graphical, desktop icon representing the browser and navigate to the URL associated with the common-entry Web page. Alternatively, the receiver of a parcel notification can click on a hyperlink embedded in the notification. This hyperlink causes the browser to launch and navigate to the common-entry Web page.

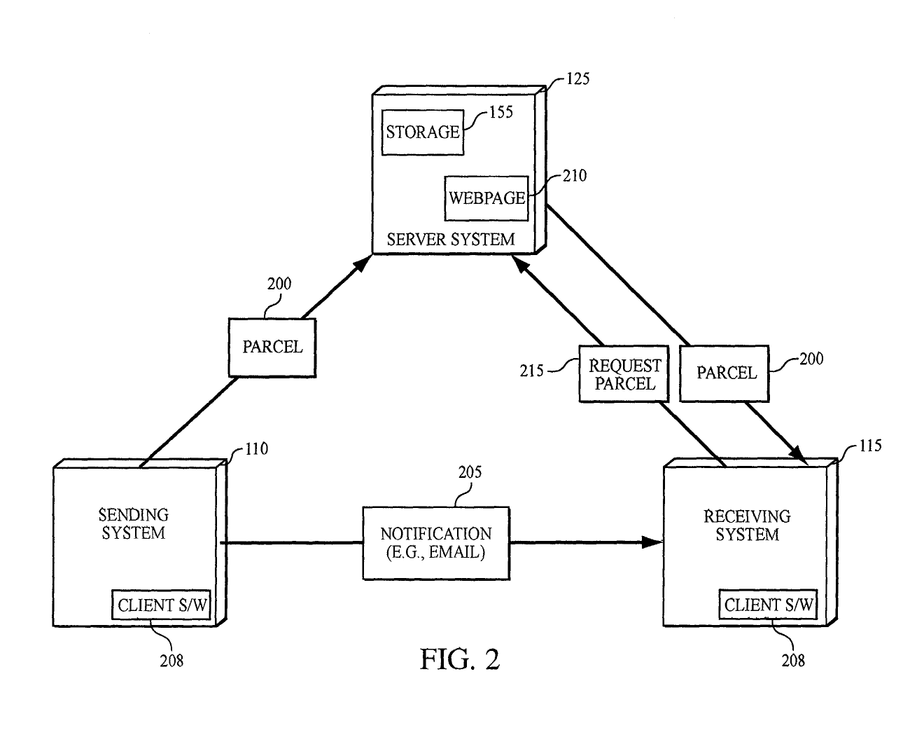

FIG. 2 shows general operation of the parcel delivery system 100. The sending system 110 transmits digital information 200, here referred to as a parcel, to the server system 125. The sending system 110 also transmits a notification 205 to the receiving system 115. The transmission of the parcel 200 and the notification 205 can occur concurrently. Alternatively, the sending system 110 can issue the notification 205 before transmitting the parcel 200 or after successfully transmitting the complete parcel 200 to the server system 125. The notification 205 can be automatically or manually generated, and may be generated before, after, or concurrently with transmission of the parcel 200. Both the sending system 110 and the receiving system 115 run the client parcel software 208.

The notification 205 signifies to the receiving system 115 that the sending system 110 has transmitted to the server system 125 a parcel intended for the receiving system 115. An e-mail message, for example, can serve as the notification 205. An advantage to using e-mail for notifications is that the sending system 110 can be assured of the on-line availability of the receiving system 115. Typical e-mail services can report to senders that particular receivers have received a particular e-mail message. Some e-mail services also can inform senders that the particular receiver has read that e-mail message. These e-mail capabilities, coupled with the capability of canceling delivery, can help reduce costs for distributing parcels by avoiding parcel deliveries to unavailable receivers.

In one implementation, the notification 205 can be a brief message, such as “You have a parcel.” If the user is familiar with the parcel delivery system 100 and knows the location of the common-entry page 210 (or, for example, has recorded the location as a bookmark in the Web browser), this notification indicating that the sending system 110 has sent the parcel, without more, may be sufficient to permit the user to access the parcel.

In another implementation, the notification 205 can also include a resource locator (e.g., a URL) addressing the common-entry page 210 on the server system 125. This resource locator can operate as a hyperlink that launches the Web browser and navigates to the common-entry page 210 with a click of the mouse. Alternatively, the receiving system 115 can manually launch the browser and enter the URL corresponding to the common entry page 210.

By having the sending system 110 notify the receiving system 115, rather than the server system 125, the receiving system 115 acquires an earlier notification of the imminent delivery of a parcel. Consequently, the receiving system 115 can take advantage of data streaming capabilities of the parcel delivery service provided by the server system 125, described below, by requesting the parcel 200 while the parcel 200 is not yet completely transmitted from the sending system 110 to the server system 125.

The server system 125 can store the parcel 200 in the storage system 155. In response to the notification 205, the receiving system 115 can access the server system 125 (e.g., at the common-entry page 210) and send a request 215 for the parcel 200. This request 215 can be automatically generated by software installed on the receiving system 115 or deliberately initiated as described above. The server system 125 can then download the parcel 200 to the receiving system 115.

To obtain the parcel 200, the receiving system 115 can access the server system 125 (e.g., using the common-entry page 210) and then traverse a sequence of graphical windows as shown in FIG. 3. The windows produce a graphical user interface that can lead the receiver to access the parcel 200. As noted above, the page 210 can be manually or automatically visited. Downloading the page 210 to the receiving system 115 can cause execution of a Common Gateway Interface (CGI) script. The script can require log-on authentication of the receiving system user and can prompt the user for log-on information 300, such as a username and a password.

After successful authentication, a second window 305 presents the user with a status of parcels received (“inbox”) and sent (“outbox”) by that user. By selecting the “inbox,” the user can obtain a list of parcels previously and presently received, and information about those parcels. The information can include the size of each parcel and an indication as to whether the user has opened that parcel. The user can select one of the listed parcels by double clicking on the desired parcel identifier. In FIG. 3, the window 305 indicates that the user has three parcels.

If, for example, the user selects parcel #1, then the next displayed window is a cover sheet 310 that provides information about attributes of the selected parcel, such as the identity of the sending system, the name of the parcel, the time sent, and the parcel size. The cover sheet 310 gives the receiving system user an opportunity to accept or reject delivery of the parcel. The receiving system user can view the attribute information, decide to refuse delivery, and consequently reject the parcel. This feature enables the user to avoid downloading oversized files, unwanted information, suspicious files, or transmissions from unknown or unwanted senders.

The cover sheet 310 can also include a resource locator, here “file,” for obtaining the selected parcel. The resource locator can include parameters that indirectly reference the storage location of the digital information representing the selected parcel. One such parameter is a unique identifier associated with the selected parcel. Other parameters can include session information, such as the identification of the user and a session key. The server system 125 maintains a data structure (e.g., a database or a table) that maps parcel identifiers to the storage locations. A CGI script processes the parameters and accesses the data structure to identify the storage location of the selected parcel, obtain the stored parcel, and start streaming the digital information to the receiving system 115.

Data streaming

Data streaming involves uploading the parcel 200 to the server system 125 while the server system 125 is downloading the parcel 200 to the receiving system 115. This process can reduce by almost half the amount of time for full delivery of the parcel 200. The time reduction occurs because the process of downloading the parcel to the receiving system 115 does not wait until the entire parcel is uploaded from the sending system 115 to the server system 125. Rather, the server system 125 can start transmitting upon receiving a first portion of the parcel 200. Data streaming can occur automatically, provided that the receiving system 115 is on-line. For implementations in which the receiving system user can reject the parcel, the receiving system 115 can request the parcel 200 from the server system 125 before the server system 125 completely receives the parcel 200 to take advantage of data streaming.

If the receiving system 115 is not on-line when the sending system 110 transmits the parcel 200 to the server system 125, the transmission can continue until the entire parcel 200 is uploaded to the server system 125. The server system 125 then waits until the receiving system 115 comes on-line and requests the parcel 200 at which point the server system 125 downloads the parcel 200 to the receiving system 115.

In one implementation, the server system 125 deletes the parcel 200 from the storage system 155 after successfully transmitting the parcel to the receiving system 115. The server system 125 also may delete portions of a parcel once those portions are delivered successfully. The receiving system 115 informs the server system 125 that a parcel or portions of the parcel have been successfully transmitted by returning acknowledgments to the server system 125 upon receiving the parcel or its portions. By deleting transmitted data, the server system 125 can make efficient use of available storage and reduce the amount of storage needed for parcels awaiting delivery to receiving systems.

Interruptibility

In the event of an interruption in the transmission of the parcel 200 from the server system 125 to the receiving system 115, the server system 125 can reestablish the connection and then resume transmission of the parcel 200 from the point of interruption. In one implementation, the receiving system 115 determines the point of interruption from the size of the parcel and the time of interruption. When the server system 125 initially sends the parcel 200 to the receiving system 115, the parcel includes a unique identifier that indicates the size of the parcel 200 to the receiving system 115. After the connection is reestablished, the receiving system 115 uses the parcel size and the time of interruption to request from the server system 125 only those portions of the parcel 200 not previously transmitted. In another implementation, the server system 125 automatically resends all portions of a parcel for which the receiving system 115 has not acknowledged receipt.

Security

The delivery system 100 provides security at various levels. At one level, the server system 125 can authenticate the user identities of the sending and receiving systems 110, 115. This authentication can include uniquely identifying the installations of the client software on the sending and receiving systems 110, 115. At another level, the delivery system 100 authenticates each delivery transaction. At another level, in preparation for transmission, the client parcel software compresses and encrypts the parcel in real time. Also, the server system 125 may compress and encrypt the parcel in real-time while transmitting the parcel to the receiving system. At still another security level, the receiving system user can reject parcel deliveries rather than download them from the server system 125.

The server system 125 can also operate as a certificate authority so that each sending and receiving system can be assured of the identity of the originator and recipient of the parcel. When acting as the certificate authority, the server system 125 manages the encryption keys of users of sending and receiving systems.

Real Time Tracking

After the sending system 110 initiates transmission of the parcel 200 to the receiving system 115, the sending system 14 can track the real-time progress of the parcel 58 through the network 30. Tracking information can include information concerning when the sending system 14 started transmitting the parcel 58 to the server system 26, the progress of uploading the parcel 58 to the server system 26 (or intermediate Web server as described below), the status of the receiving system 18 (e.g., unregistered, off-line, or on-line), the progress of downloading the parcel 58 to the receiving system, and the status of the received parcel (e.g., parcel being received, parcel moved to another location in memory, parcel delivered, parcel opened, or time of opening). The server system 26 can verify that the receiving system 18 has received the parcel 58 using a signature uniquely identifying the receiving system 18 user and, when the receiving system 18 executes client software to access the server system 26, a unique identifier associated with that client software. The signature and unique identifier can accompany a returned acknowledgment from the receiving system 18 to securely signify that the receiving system 18 has received from the server system 26 the last bit of digital information pertaining to the parcel 58.

The server system 26 can record the progression of the transmission for the parcel 58 in a database, along with the signature and client software identification. The database can provide an audit trail for the sending and receiving systems 14, 18 to view. Accordingly, tracking provides the sending system 14 with a mechanism for confirming receipt and subsequent use of a parcel 58, a capability generally lacking in trans-Internet communications.

Delivery Cancellation

The sending system 110 can cancel delivery of the parcel 200 at any time during the transmission of the parcel to the receiving system 115. The sending system 110 does so by signaling the server system 125 to stop the delivery. If the server system 125 has not started transmitting the parcel to the receiving system 115, then the server system 125 can forego forwarding the parcel and can delete the parcel from the storage system 155. If the server system 125 has transmitted the parcel to the receiving system 115, then the server system 125 can forward the cancel signal to the receiving system 115. The client software on the receiving system 115 deletes the parcel upon receiving the cancel signal from the server system 125, provided that the parcel has not completely received and opened. Conceivably, a completely delivered and opened parcel may be canceled, although permission by the user of the receiving system may be necessary to do so. Upon request by the sender, the server system 125 can recover any canceled deliveries, provided that the parcel is still available (e.g., it has not been overwritten).

Two-Server Systems

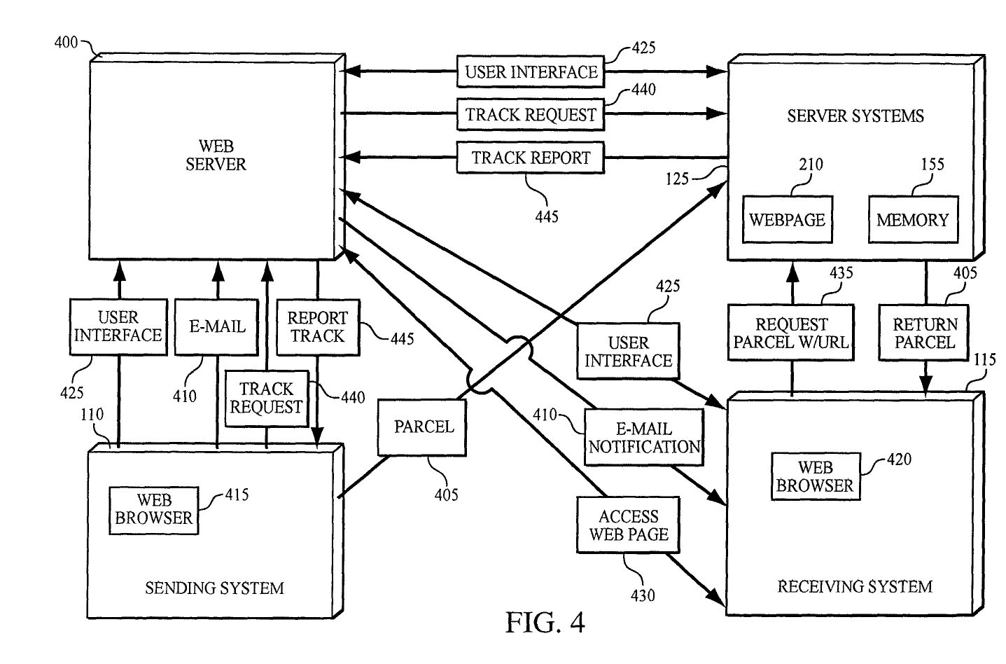

Referring to FIG. 4, another implementation of the electronic parcel delivery system 100 includes the sending system 110, the receiving system 115, the server system 125, and a Web server 400. The sending and receiving systems 100, 115 are in communication with the Web server 400 and the server system 125, and the Web server 400 is in communication with the server system 125. A parcel 405 passes directly from the sending system 110 to the server system 125, and the server system 125 stores the parcel 405 in the storage system 155. The sending system 110 sends a notification 410 to the Web server 400, and the Web server 400 provides the notification 410 to the receiving system 115. The notification 410 operates similarly to the notification 205 described with referenced to FIG. 2, and may be in the form of an e-mail message.

In this implementation, the sending and receiving systems 110, 115 run Web browsers 415, 420 to access the common-entry page 210 on the server system 125. The Web server 400 transmits graphical user interfaces 425 between the sending and receiving systems 110, 115 and the server system 125. The graphical user interfaces are displayed by the browsers 415, 420.

Upon receiving a notification 410, the receiving system 115 uses browser 420 to request access to the Web page 210, and does so by sending a request 430 to the Web server 400. The Web server 400 responds by presenting the user interface 425, which permits the receiving system 115 to obtain a uniform resource locator (“URL”) for use in accessing the parcel 405. The receiving system 115 then sends a request 435 containing the URL to the server system 125, which responds by sending the parcel 405.

The sending system 110 can track the status of a parcel by sending a tracking request 440 to the Web server 400. The Web server 400 forwards the tracking request 440 to the server 125, which responds with a tracking report 445. The tracking report 445 details the delivery status of parcel 405. The Web server 400 forwards the tracking report to the sending system 110.

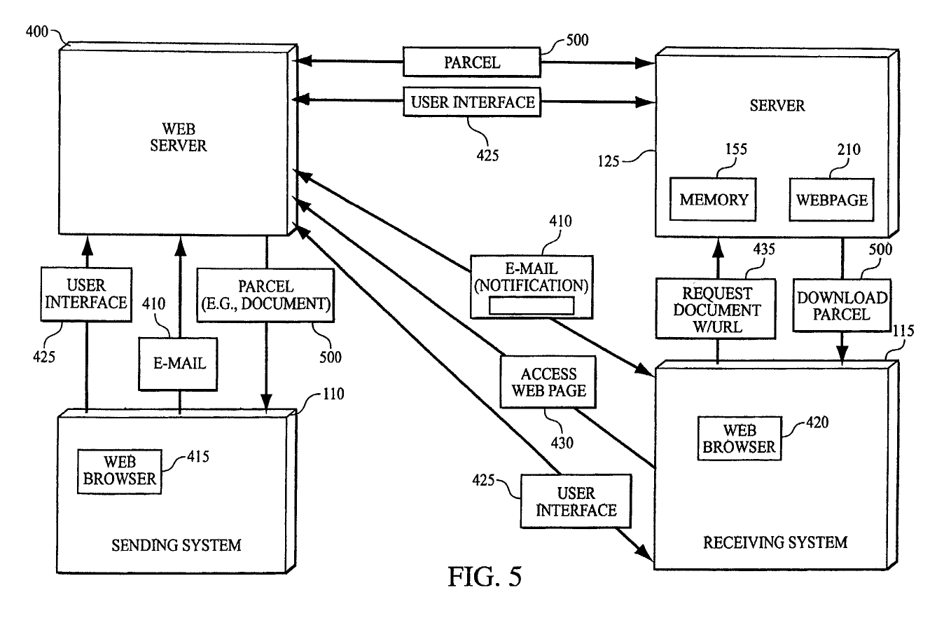

Referring to FIG. 5, in another implementation of the parcel delivery system 100, the sending system 110 transmits a parcel 500 to the Web server 400 instead of directly to the server system 125. The Web server 400 then forwards the parcel 500 to the server system 125. The system otherwise operates in the same way as the system of FIG. 4.

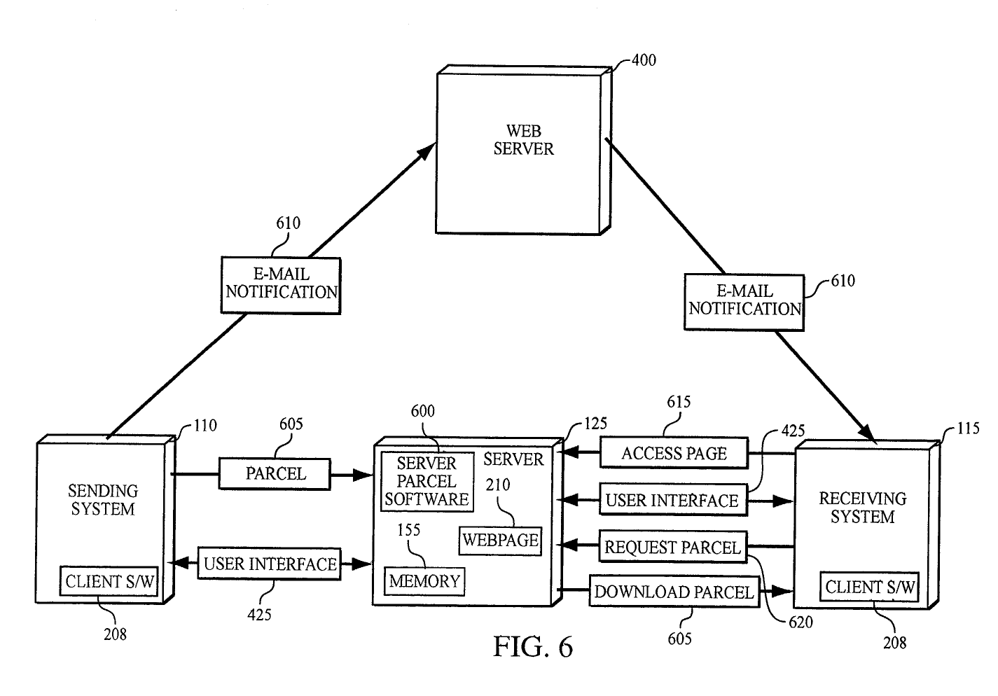

Referring to FIG. 6, in another implementation of the parcel delivery system 100, the sending and receiving systems 110, 115 each execute the client parcel software 208 to access server parcel software 600 executing on the server system 125. Like the implementation of FIG. 4, the sending system 110 transmits a parcel 605 directly to the server system 125 and transmits a notification 610 to the Web server 400, preferably via an e-mail message or the like. The Web server 400 forwards the notification 610 to the receiving system 115. The receiving system 115 responds to the notification 610 by sending a request 615 to access the Web page 210 of the server system 125 and by sending a parcel request 620 to the server system 125. The server system 125 responds by forwarding the parcel 605 to the receiving system 115. In contrast to the implementation of FIG. 4, the user interfaces, tracking requests, and tracking reports pass directly between the sending system 110 (or the receiving system 115) and the server system 125, rather than through the Web server 400.

In other implementations, the sending system 110 can execute a Web browser, as described, e.g., in FIG. 5, while the receiving system 115 executes the client parcel software. Similarly, the sending system 110 can execute the client parcel software while the receiving system executes a Web browser as described, e.g., in FIG. 5. Generally, in such implementations, the client parcel software communicates directly with the server system 125 to exchange information, such as the user interface and the tracking information, and the Web browser communicates indirectly with the server system 125 through the Web server 400.

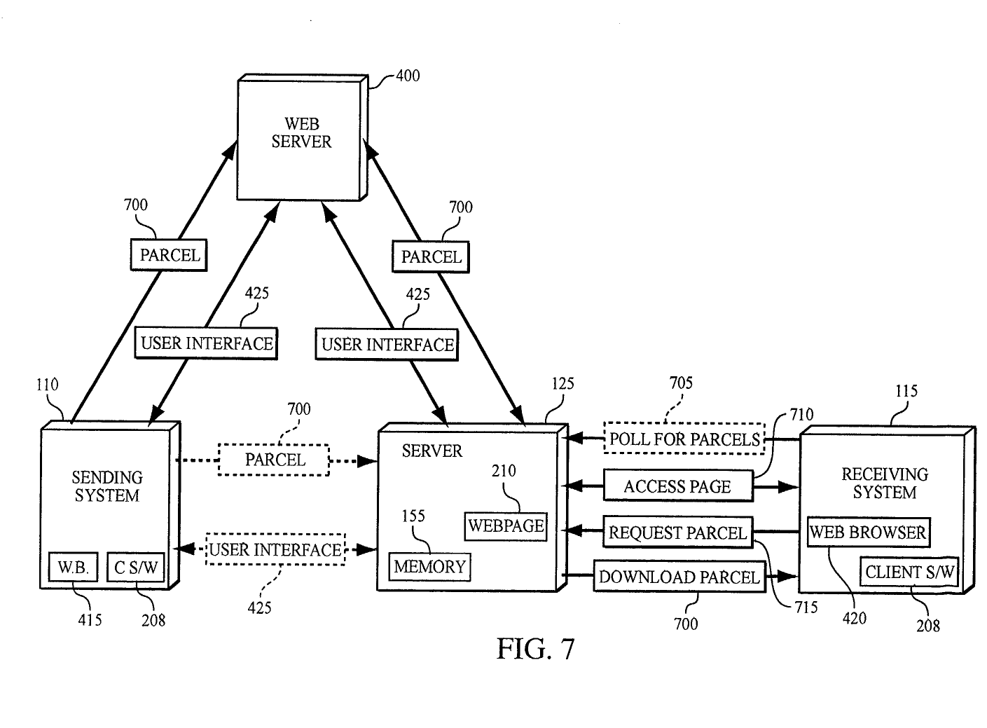

Referring to FIG. 7, in another implementation of the parcel delivery system 100, the sending system 110 delivers a parcel 700 to the server system 120 without any notification mechanism to alert the receiving system 115 that the sending system 110 has sent the parcel 700. The sending system 110 can transmit the parcel 700 directly to the server system 115 or through the Web server 400. For instance, when the sending system 110 executes the client parcel software, the user interface 425 and the parcel 700 are communicated directly to the server system 125. When the sending system 110 executes the Web browser 415, the parcel and the user interface are communicated through the Web server 400.

When the receiving system 115 goes online, a URL is presented to the user in a graphical user interface enabling the receiving system user to obtain the parcel. Alternatively, the receiving system 115 can periodically poll 705 the server system 125 to determine if any new parcel deliveries have occurred. When there is a parcel to be delivered, the receiving system 115 accesses 710 the Web page 210 and requests 715 the parcel. The server system 125 responds by sending the parcel.

Scalable Server Architecture

Referring to FIG. 8, a group of servers may act logically as the server system 125. The group of servers includes a root server 800, one or more user servers 805, 810, and one or more data servers 815. The root server 800 tracks each user server 805,810 and each data server 815 in the group. The root server 800 also can maintain information about other remote server systems or groups of server systems that can provide the electronic parcel delivery service in conjunction with the server system 125.

The user of the sending system 110 and the user of the receiving system 115 are each assigned to a user server when the users first register with the server system 125. The root server 800 selects the user server to which each user is assigned. For example, the root server 800 can assign the sending system user to user server 805 and the receiving system user to user system 810, as shown, or may assign the sending and receiving system users commonly to a single user server, e.g., user server 805. When the sending system 110 subsequently contacts the server system 125 to initiate delivery of a parcel, the sending system 110 obtains the identity of the assigned user server 805 from the root server 800 (arrow 820). The sending system 110 then sends parcel information, including the name of the intended receiver, to the user server 805 (arrow 825).

In response to the communication from the sending system 110, the user server 805 allocates one of the data servers 815 to store that parcel (arrow 855) and notifies the sending system 110 of the allocation (arrow 825). The sending system 110 can then transmit the parcel directly to the allocated data server 815 through link 830. The assigned user server 805 provides, each other user server 810 in the group (and remote user servers) with the identity of the intended receiver of the parcel through link 835.

Upon logging on to the server system 125, the receiving system 115 obtains from the root server 800 the identity of the user server 810 assigned to the receiving system 115 (arrow 840). The receiving system 115 subsequently communicates with the user system 810 to determine that the new parcel is available on the data server 815 (arrow 845). The user server 810 is able to communicate this information to the receiving system 115 based on the information previously communicated between the user server 805 assigned to the sending system user and the user system 810 assigned to the receiving system user. However, it is also possible for the user system 810 to query the user system 805 for such information. The user server 810 gives the receiving system user a session key that the receiving system 115 uses to contact the data server 815 and retrieve the parcel (arrow 850). The data server 815 captures the transaction information as described above, which can be useful in preparing billing information.

Proxy System

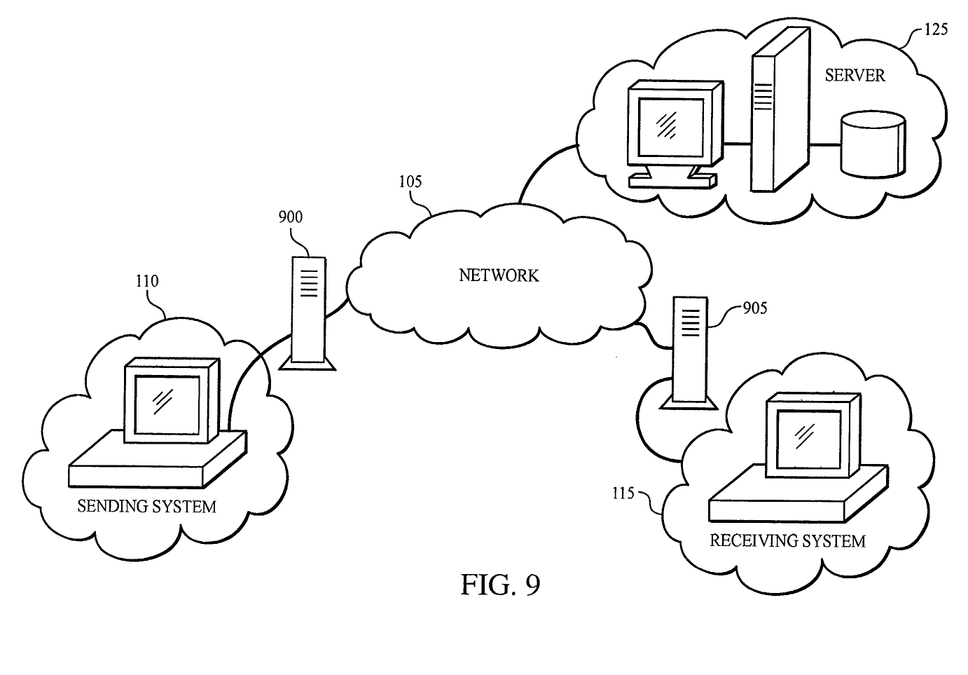

Referring to FIG. 9, in another implementation of the electronic parcel delivery system 100, proxy servers 900 and 905 are connected between the network 105 and, respectively, the sending system 110 and the receiving system 115. While shown in FIG. 9 as two distinct proxy servers 900 and 905, in some implementations the proxy servers 900 and 905 can be included in the same proxy server. In addition, while shown in FIG. 9 as singular systems, proxy servers 900 and 905 may each include several interconnected servers or systems of servers.

Each of proxy servers 900 and 905 works in conjunction with a firewall (not shown) to allow communications to and from the network 105 by the sending and receiving systems 110 and 115. Consequently, for the sending and receiving systems 110 and 115 to exchange parcels through the server system 125, the parcels must satisfy criteria established by the proxy servers 900 and 905 to avoid being blocked from passing through the respective proxy server.

In one implementation, the proxy servers 900 and 905 are HTTP proxy servers that communicate using HTTP messages (i.e., transactions). In general, the format of each HTTP transaction generally includes an initial line followed by zero or more header lines, an empty line (i.e., carriage return, line feed (CRLF)), and an optional message body:

Initial line (e.g. request or response transaction)

Optional header line 1: value 1 CRLF

Optional header line 2: value 2 CRLF

Optional header line X: valueX CRLF

CRLF

message body.

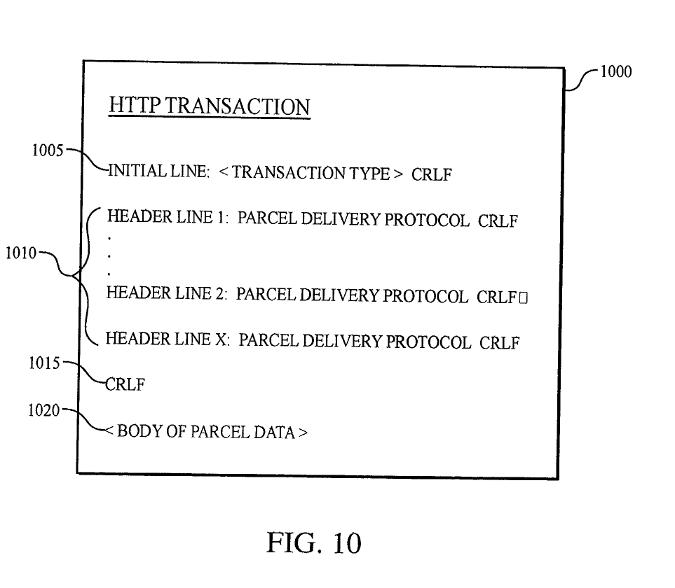

FIG. 10 illustrates an exemplary format and content of an exemplary HTTP transaction 1000 for use in transmitting a parcel through an HTTP proxy server. The HTTP transaction 1000 includes an initial line 1005, one or more header lines 1010, a blank line (CRLF) 1015, and the digital information 1020 associated with the transaction 1000. The digital information 1020 represents, for example, a portion of the parcel being transmitted, a parcel description, and parcel commands. The initial line 1005 indicates the type of HTTP transaction (e.g., POST and GET commands). The header lines 1010 include protocol information used by the sending, server, and receiving systems to direct the operation of the parcel delivery service. The parcel delivery service protocol specifies rules for conducting parcel delivery transactions such as, for example, authentication, uploading and downloading parcels, requesting a list of parcels that can be uploaded and downloaded, sending, receiving and tracking parcels, and performing commands, such as cancel delivery, mark parcel as open, and mark parcel as moved.

Generally, parcels are large files or documents that cannot be completely transmitted with a single HTTP transaction. Accordingly, for large parcels, multiple HTTP transactions are typically necessary to transmit the entire parcel from the sending system 110 to the server system 125 or from the server system 125 to the receiving system 115. Each HTTP transaction therefore generally transfers only a portion of the parcel. For such HTTP transactions, the digital information 1020 represents the parcel data included in the transaction that is being transmitted by the sending system 110 or requested by the receiving system 115.

In one implementation, the digital information 1020 is binary data. Where the proxy server objects to pure binary data, other implementations may have the sending system 110 or the server system 125 convert the pure binary data into printable characters (e.g., by creating hexadecimal values for each byte). The receiver of the converted data, either the server system 125 or the receiving system 115, converts the printable characters back into pure binary data.

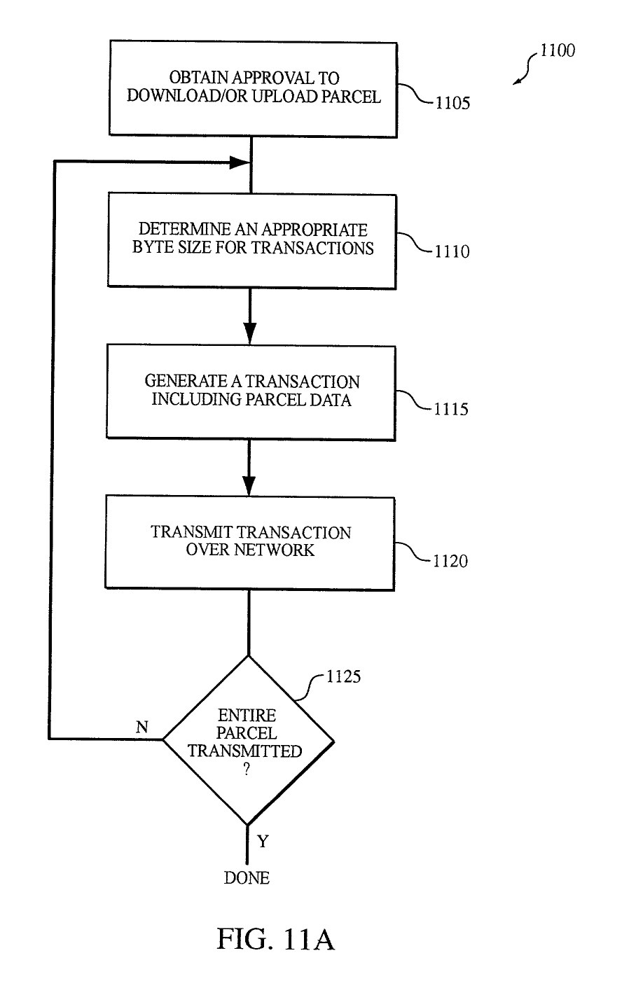

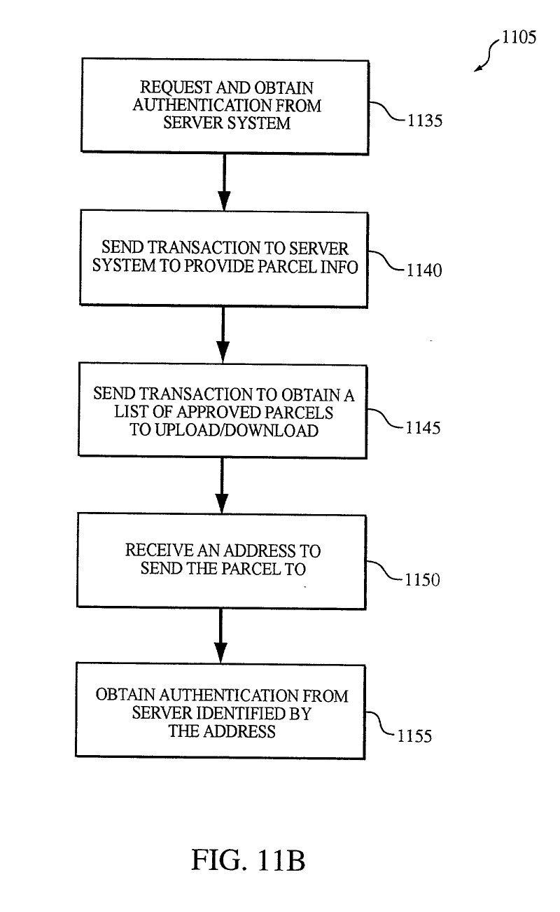

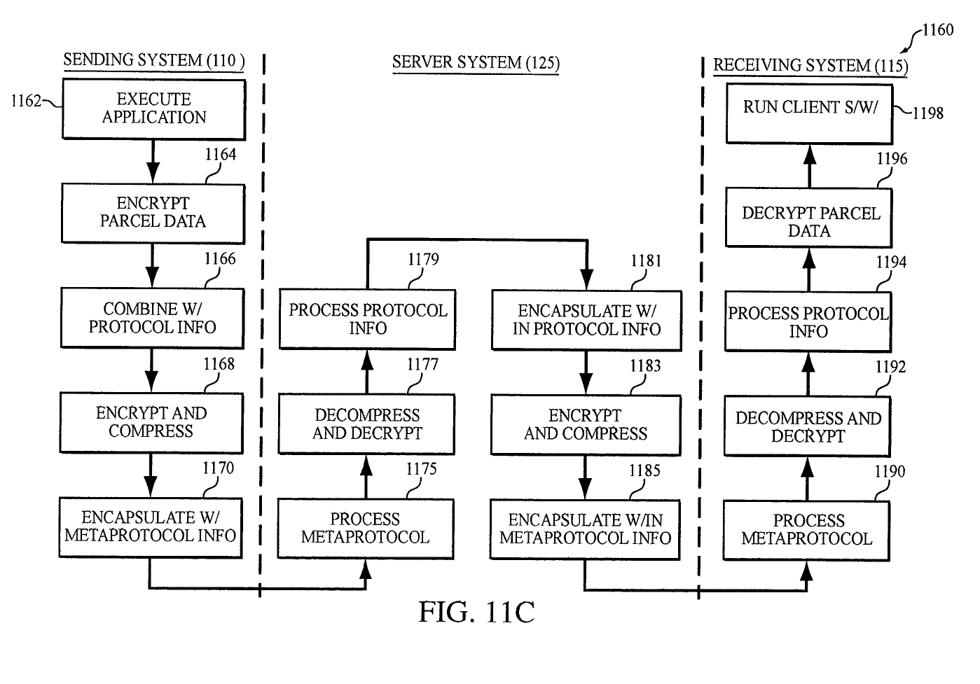

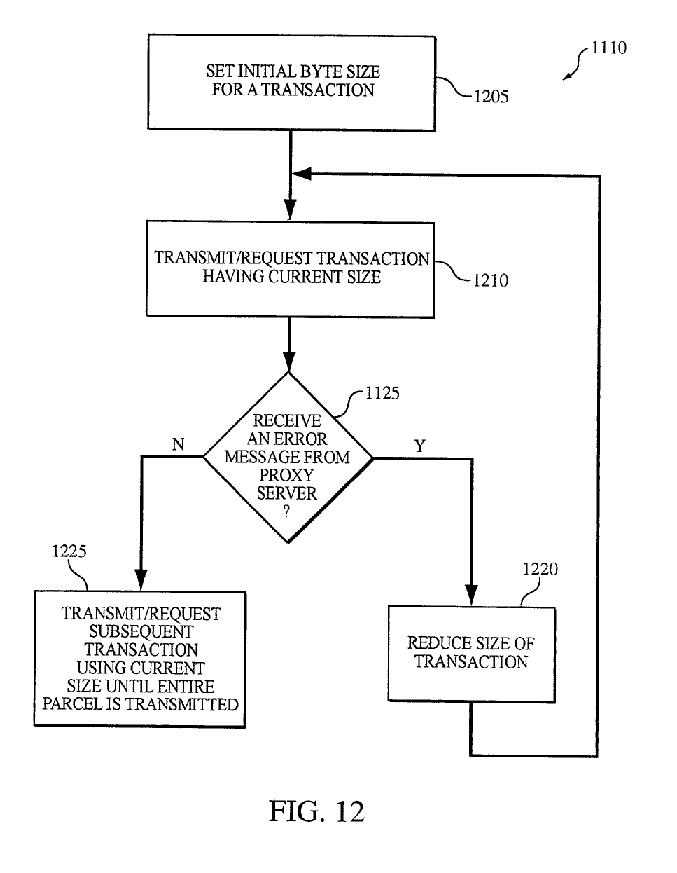

Referring to FIG. 11A, the sending system 110 transmits a parcel to the server system 125 according to a procedure 1100. In general, the client parcel software executing on the sending system 110 follows a series of parcel delivery protocol steps until the sending system 110 obtains approval from the server system 125 to upload the parcel (step 1105). (An example of this process is illustrated and described in greater detail with respect to FIGS. 11B and 11C.) The sending system 110 then determines an appropriate byte size for transmitting transactions through the proxy server 900 (step 1110). (An example of this process is illustrated and described in greater detail with respect to FIG. 12.) Next, the sending system 110 generates a transaction that includes a portion of the parcel corresponding to the determined byte size (step 1115). Finally, the sending system 110 transmits that transaction to the server system 125 (step 1120). Steps 1110-1120 are repeated until the entire parcel passes to the server system 125 (step 1125).

The receiving system 115 follows a similar process when requesting a parcel from the server system 125. The client software executing on the receiving system 115 follows a series of parcel delivery protocol steps until the receiving system 115 obtains approval from the server system 125 to download the parcel (step 1105). The receiving system 115 specifies the appropriate byte size when requesting delivery of the parcel from the server system 125 (step 1110). Finally, the receiving system 115 generates the transaction (step 1115) that the server system 125 fulfills by sending a portion of the parcel corresponding to the determined byte size (step 1120). Steps 1110-1120 are repeated until the entire parcel passes to the receiving system 115 (step 1125).

Referring to FIG. 11B, the sending system 110 performs a series of parcel delivery protocol steps 1105 to obtain approval from the server system 125 to upload the parcel. The receiving system 115 follows a similar process when requesting a parcel for downloading from the server system 125. The sending system 110 issues a transaction (e.g., an HTTP transaction) to the server system 125 to request authentication from the server system 125 (step 1135). The server system 125 authenticates the sending system 110 by ensuring that the user of the sending system 110 has an account with the parcel delivery service. In general, the server system 125 achieves authentication through use of a password authentication process. For instance, the server system 125 establishes an account for the sending system user by having the user engage in a registration procedure. During registration, the sending system user provides personal information, such as a name, an address, and credit card information, to the server system 115. The systems 110 and 125 then establish the password. Once authenticated, the server system 125 responds to the authentication request from the sending system 110 by returning a session handle for use by the sending system 110 in subsequent transactions.

The sending system 110 then sends a transaction to the server system 125 (step 1140) to provide parcel information associated with one or more parcels that the sending system 110 wants to deliver through the server system 125. The parcel information can include, for example, parcel attributes (such as size, name, and parcel type), a billing account number, recipients, and text message information. In response to this transaction, the server system 125 validates the parcel information. Upon successful validation, the server system 125 assigns a server for receiving the parcel. Also, the server system 125 notifies the assigned server and any server associated with the recipients designated in the parcel information to prepare for the pending parcel transfer.

The sending system 110 then issues a transaction to get a list of those parcels that the server system 125 permits the sending system 110 to send (step 1145). The server system 125 responds with the list of parcels and the address of a server to which the sending system 110 is to send the parcels (step 1150). In one implementation, the address references the server system 125. In another implementation, the address references another server system in the group of server systems.

Included in the response to the sending system 110 is an encrypted key that the sending system 110 uses for authentication with the server system referenced by the address. After the referenced server system (e.g., server system 125) authenticates the sending system 110 with the key (step 1155), the referenced server system provides the sending system 110 with another session handle that is used for uploading the parcel from the sending system 110 to the referenced server system.

FIG. 11C illustrates an exemplary process 1160 by which the sending system 110 transmits a parcel to the server system 125, and by which the server system 125 transmits the parcel to the receiving system 115. The sending system 110 executes the client parcel software (step 1162). In some implementations, the sending system 110 includes encryption software for encrypting parcel data of each parcel portion (step 1164). The encryption software can employ any combination of one or more asymmetric or symmetric encryption algorithms to encrypt the parcel data. If the server system 125 is acting as a certificate authority, then the server system 125 possesses each key used in the encryption process. If another entity is acting as a certificate authority, in addition to or instead of the server system 125, then the server system 125 does not possess the key or keys for decrypting this encryption, and the encryption seals the contents of the parcel from discovery by the server system 125.

The sending system 110 then combines the encrypted parcel data with the parcel delivery protocol information described above (step 1166). Before placing the encrypted and encapsulated parcel onto the network, the sending system may again encrypt and compress the parcel data along with the protocol information using encryption software that the server system 125 can decipher (step 1168). In some implementations, the parcel data is excluded from this second encryption step. The compression reduces the required network bandwidth for conveying the parcel. The sending system 110 then encapsulates the encrypted and compressed parcel delivery protocol information and parcel data within meta-protocol information, e.g., the HTTP protocol, to produce the transaction (step 1170).

The sending system 110 transmits the transaction to the server system 125 as described above and notifies the receiving system 115 (not shown). The server system 125 receives the transaction and processes the meta-protocol information in the transaction (step 1175). The server system 125 then decompresses and decrypts the processed meta-protocol information to obtain the parcel delivery protocol information (step 1177). Next, the server system 125 processes the parcel delivery protocol information and stores the parcel data (step 1179). Steps 1162 to 1179 are repeated until the server system 125 receives the entire parcel from the sending system 110. The parcel remains stored at the server system 125 until the receiving system 115 requests the parcel or until a predetermined time period elapses.

In response to the notification from the sending system 110 (not shown), the receiving system 115 executes the client parcel software to access the parcel delivery service operating on the server system 125 as described above. The receiving system user provides logon information so that the server system 125 can authenticate the identity of the user. As with the sending system user, the server system 125 establishes an account for the receiving system user by having the user engage in a registration procedure during which the server system 125 obtains personal information about the receiving system user.

To transmit the parcel, transaction by transaction, the server system 125 combines each portion of parcel data with parcel delivery protocol information (step 1181). The server system 125 then encrypts and compresses the parcel portion (step 1183). The server system 125 may use the encryption algorithm used by the sending system 110, and may also use an additional or alternative encryption algorithm. The use of different algorithms provides the flexibility to use the delivery system 100 across various international domains that can have varying restrictions on the type of encryption. The server system 125 then encapsulates the encrypted and compressed data within meta-protocol information that enables the transaction to pass through the proxy server 905 (step 1185).

Upon obtaining the parcel portion, the receiving system 115 processes the metaprotocol information (step 1190). The receiving system 115 then decompresses and decrypts the processed data to obtain the parcel delivery protocol information (step 1192). Next, the receiving system 115 processes the parcel delivery protocol information as directed by that information (step 1194), and then decrypts the parcel data in the transaction (step 1196). Finally, the receiving system passes the parcel data to the client parcel software.

The electronic parcel delivery system 100 can deliver parcels of any size. However, proxy servers generally limit the amount of data that can pass through the firewall for a given transaction. Accordingly, the sending system 110 and the receiving system 115 keep each transmitted or requested parcel portion within the size limit imposed by the proxy servers. The number of portions needed to transmit a parcel depends upon the overall size of the parcel and this size limit.

FIG. 12 illustrates an exemplary process 1110 by which the sending system 110 or the receiving system 115 dynamically determines the byte size of a transaction. Initially, the sending system 110 uses a predetermined size for a transaction (step 1205). In general, delivery performance improves with increasing parcel portion size. Accordingly, implementation, the predetermined size corresponds to the maximum size limit typically imposed by proxy servers on the network 105, which is four megabytes. The sending system 110 transmits the transaction with the predetermined size (step 1210), and the proxy server 900 intercepts the transaction. If the size of the transaction exceeds the size limit allowed by the proxy server 900, then the proxy server 900 blocks further transmission of the transaction and reports an error.

Upon receiving an error message from the proxy server (step 1215), the sending system 110 reduces the transaction size (step 1220). In one implementation, the transaction size is halved (e.g., a 4 Mb portion becomes a 2 Mb portion); however, other criteria for reducing the transaction size can be used. The sending system 110 then attempts to transmit the transaction having the new, smaller size (step 1210). If the sending system 110 receives another error message (step 1215), the sending system reduces the transaction size again (step 1220). The process of transmitting and reducing continues until the sending system 110 no longer receives an error message from the proxy server 900 because of the size of the transmitted transaction (step 1215).

The server system 110 then transmits the remaining portions of the parcel using the current parcel portion size that successfully passed through the proxy server 900 (step 1225). In another implementation, the sending system 110 further improves the parcel portion size by attempting to transmit a parcel portion with a larger size than the current size, but with a smaller size than the parcel portion that was last rejected by the proxy server 900.

The receiving system 115 performs process 1110 in a similar manner when requesting the parcel from the server system 125. Initially, the receiving system 115 uses a predetermined size for a transaction (step 1205). The receiving system 115 requests the transaction with the predetermined size (step 1210), and the proxy server 905 intercepts the transaction. If the size of the transaction exceeds the size limit allowed by the proxy server 905, then the proxy server 905 prevents the receiving system 115 from receiving the transaction and produces an error message.

Upon receiving an error message (step 1215), the receiving system 115 reduces the size of the transaction and requests the transaction having the reduced size (step 1210). If the receiving system receives another error message, the receiving system reduces the transaction size again (step 1220). The process of transmitting and reducing continues until the receiving system no longer encounters an error because of the size of the transmitted transaction. The receiving system subsequently requests the remaining portions of the parcel using the current transaction size that successfully passed through the proxy server 905 (step 1225).

In addition to dynamically determining the size of transmitted parcel portions, the sending system 110 can also dynamically determine the format of information encapsulated within the header of the meta-protocol. For example, the inclusion of information following the required information within the header of the HTTP protocol can have a variety of formats. Some proxy servers impose restrictions on these formats. For example, one proxy server can restrict the number of bytes of information within a particular line within the HTTP header.

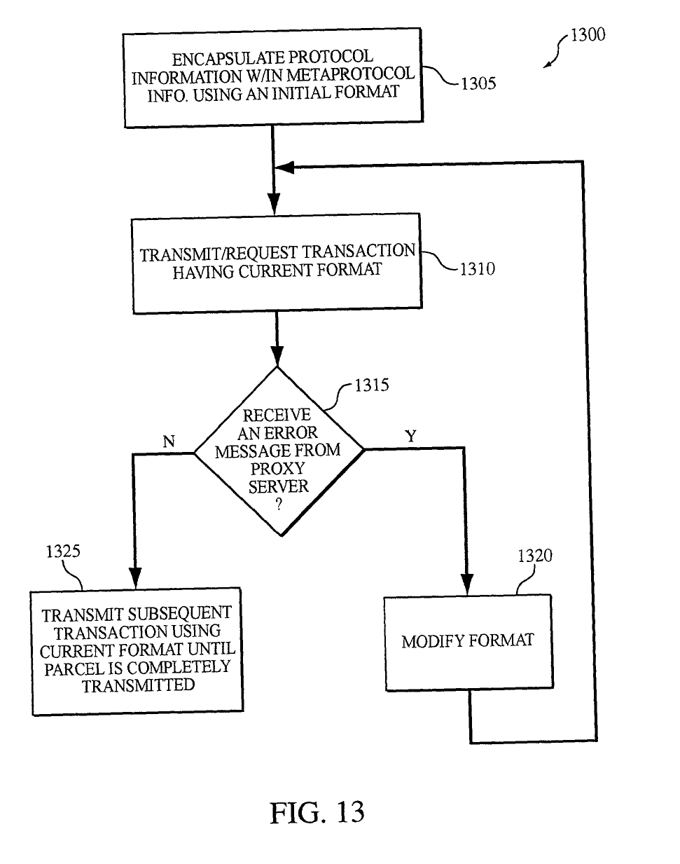

FIG. 13 illustrates an exemplary process 1300 by which the sending system 110 or the receiving system 115 dynamically determines the format of the delivery service protocol information encapsulated within the meta-protocol information. Initially, the sending system 110 encapsulates delivery service protocol information using a predetermined format (step 1305). For example, the predetermined format for encapsulating one kilobyte of protocol data can be four header lines with each header line having 256 bytes.

The sending system 110 transmits the transaction with the initial format (step 1310), and the proxy server 900 intercepts the transaction. If the proxy server 900 objects to the current format, the proxy server 900 blocks further transmission of the transaction and reports an error to the sending system 110. Upon receiving the error message (step 1315), the sending system 110 alters the format (step 1320). In one implementation, the sending system 110 reduces the number of bytes per header line by half (e.g., 256 bytes per line become 128 bytes per line) and doubles the number of header lines. Again, the sending system 110 can use other criteria for reducing the number of bytes per line within the header. The sending system 110 then attempts to transmit the transaction with the new format (step 1310).

Typically, reducing the number of bytes per header line to 128 bytes enables the transaction to pass through the proxy server 900. If the sending system 110 again receives an error message (step 1315), the sending system alters the format again (step 1320). Transmitting the transaction (step 1310) and altering the format (step 1320) continue until the sending system 110 no longer receives an error message from the proxy server 900 because of the format of the transmitted transaction.

The sending system 110 subsequently transmits the remaining parcel portions of the parcel using the current format that successfully passed through the proxy server 900 (step 1325). In another implementation, the sending system 110 improves the format by attempting to transmit a parcel portion with a format having more bytes per header line than the current format, but with fewer bytes per line than the format of the transaction that last failed to pass through the proxy server 900.

The receiving system 115 performs the process described in FIG. 13 in a similar manner when requesting the parcel from the server system 26. The receiving system 18 encapsulates delivery service protocol information using a predetermined initial format as described above (step 1305). The receiving system 115 transmits the transaction with the initial format (step 1310), and the proxy server 905 intercepts the transaction. If the proxy server 905 objects to the current format, the proxy server 905 blocks further transmission of the transaction and reports an error to the receiving system 115. Upon receiving the error message (step 1315), the receiving system 115 alters the format (step 1320). The receiving system 115 then attempts to transmit the transaction with the new format (step 1310).

If the receiving system 115 again receives an error message (step 1315), the format is altered again (step 1320). Transmitting the transaction (step 1310) and altering the format (step 1320) continue until the receiving system 115 no longer receives an error message from the proxy server 905 because of the format of the transmitted transaction. The receiving system 115 subsequently transmits the remaining parcel portions of the parcel using the current formal that successfully passed through the proxy server 905 (step 1325).

Application to Electronic Commerce

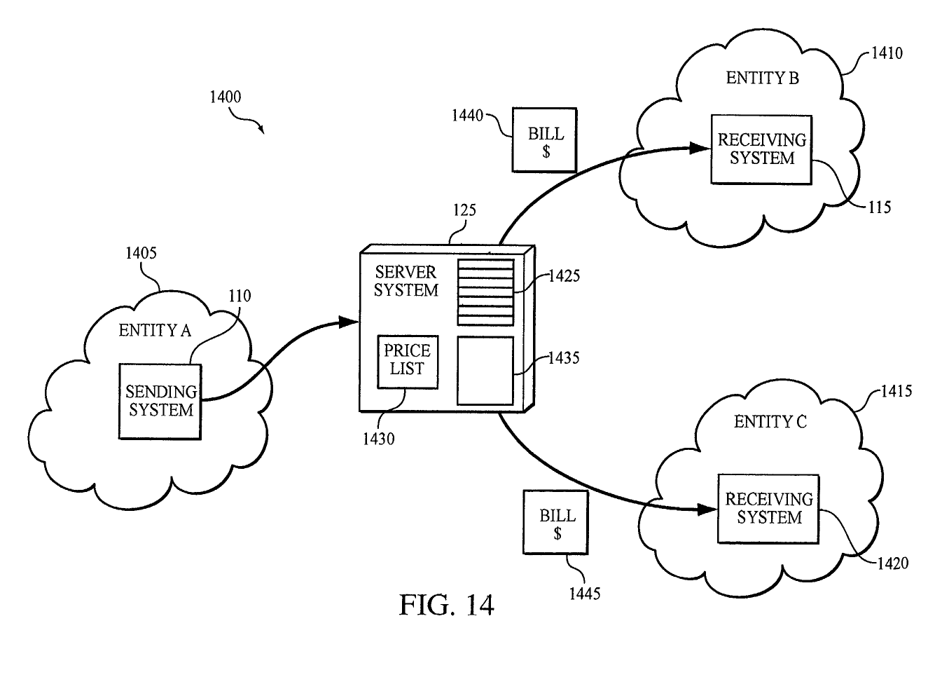

The electronic parcel delivery system 100 can be integrated into different business operations. FIG. 14 illustrates an exemplary implementation 1400 in which the electronic parcel delivery system 100 facilitates the conducting of electronic commerce. As shown, entity A 1405 operates the sending system 110, entity B 1410 operates the receiving system 115, and entity C 1415 operates a second receiving system 1420. The server system 125 includes software 1425, e.g., APIs (Application Program Interfaces), for defining the transactions that can be performed by sending and receiving systems 110, 115, 1420. For example, if the entity a 1405 is in the business of delivering electronic newspapers, then defined transactions can include, for example, delivering a newspaper, subscribing to the newspaper, opening an electronic newspaper by a receiving system, and canceling a subscription.

The server system 125 also stores a software data structure 1430 (e.g., a table) that associates a fee with each defined transaction. The data structure 1430 operates as a price list. The software 1425 includes a software module that maintains a record 1435 of the transactions performed by the sending system 110 and each receiving system 115, 1420. Another software module calculates an amount owed by each sending and receiving system by referencing the record 1435 of performed transactions and the pricing list 1430. The server system 125 can then generate invoices 1440, 1445 specifying the amount owed by each system. The server system 125 can deliver such invoices 1440,1445 for payment to each receiving system 115, 1420, or can charge their respective accounts.

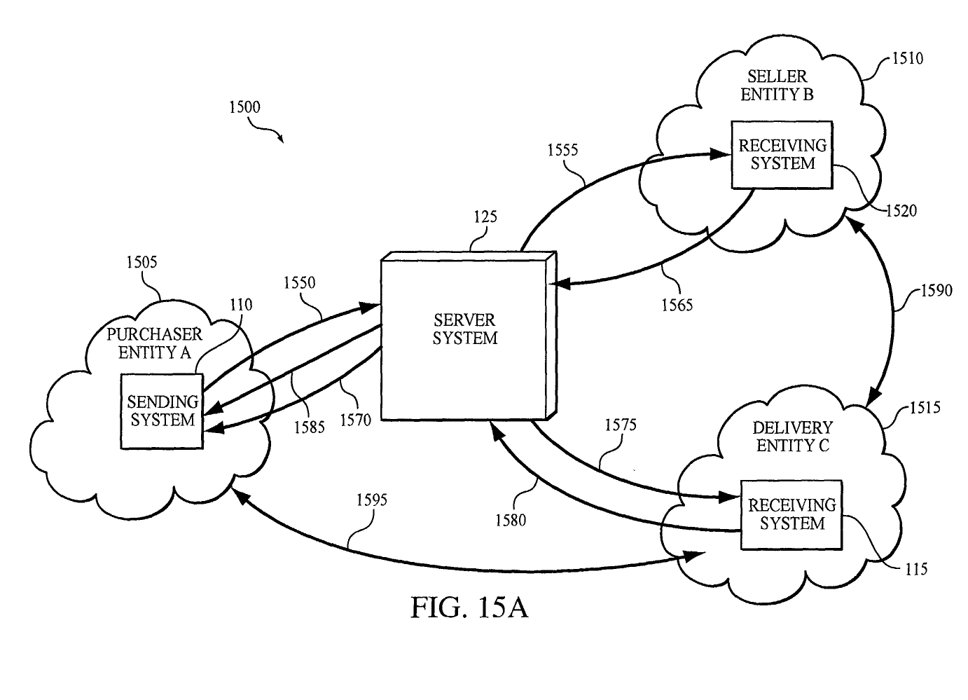

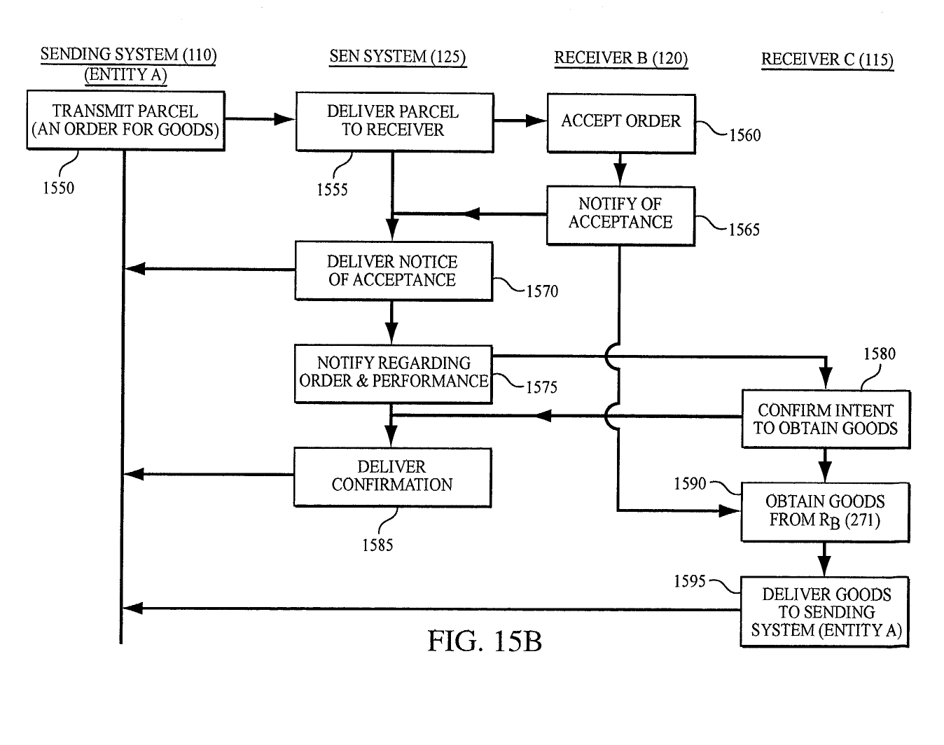

FIGS. 15A and 15B illustrate an exemplary implementation of the electronic delivery system 10 in which the delivery service, operating on the server system 125, coordinates the purchase and delivery of a product among a purchaser entity A 1505, a seller entity B 1510, and a delivery entity C 1515. The sending system 110 of the purchaser entity A 1505 transmits a parcel to the server system 125 for subsequent delivery to the receiving system 1520 of the seller entity B 1510 (step 1550). For example, the parcel can be an order for 100 automobile parts.

Upon receiving the parcel (e.g., an order), the server system 125 transmits the parcel to the receiving system 1520 of seller entity 1510 (step 1555). As an alternative, the sending system 110 can send a notification of the parcel to the receiving system 1520 of seller entity 1510, which can then contact the server system 125 to request the parcel.

The receiving system 1520 accepts the order (step 1560) and sends a notification of acceptance to the server system 125 (step 1565). The server system 125 delivers the notification of acceptance to the sending system 110 (step 1570), and then notifies the receiving system 115 of the order (step 1575). The receiving system 115 then confirms with the server system 125 that it intends to obtain and deliver the goods associated with the parcel (e.g., order) (step 1580), and the server system 125 delivers this confirmation to the sending system 110 (step 1585).

Finally, entity C, which includes the receiving system 115, obtains the goods from entity B, which includes the receiving system 1520 (step 1590), and delivers the goods to entity A, which includes the sending system 110 (step 1595). Goods may be delivered physically (e.g., by truck) or electronically, as appropriate.

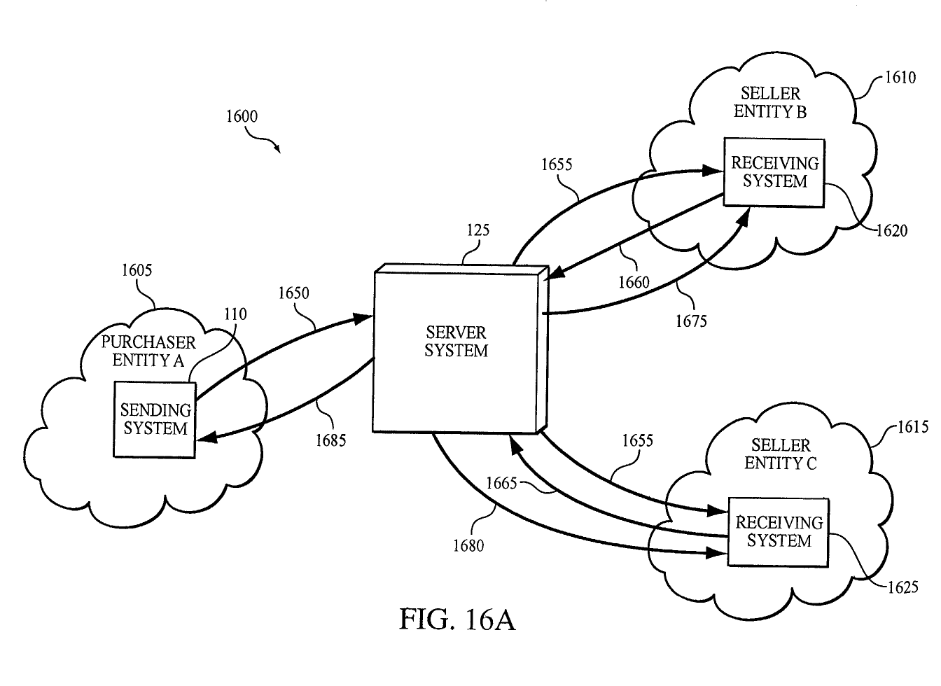

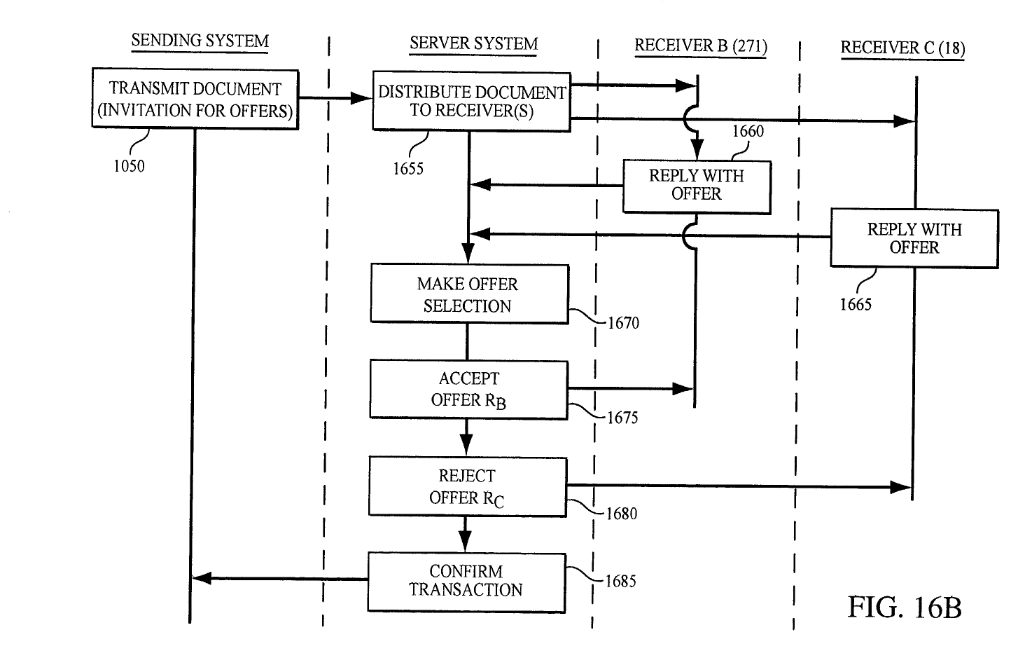

FIGS. 16A and 16B illustrate an exemplary implementation 1600 of the electronic delivery system 100 in which the delivery service, operating on the server system 125, controls work flow in an operation involving a purchaser entity A 1605, a seller entity B 1610, and a seller entity C 1615. The sending system 110 of the purchaser entity A 1605 transmits a parcel to the server system 125 for subsequent delivery to receiving systems 1620, 1625 of entities 1610, 1615, respectively. In one implementation, the parcel is an invitation for offers regarding the price of particular goods (e.g., 100 automobile parts). In conjunction with sending the parcel to the server system 125, the sending system 100 may notify each receiving system 1620, 1625 that the invitation is available at the server system 125. Each receiving system 1620, 1625 obtains the parcel (step 1655) and replies with an offer (steps 1660, 1665).

In response to the offers, the server system 125 selects an offer (step 1670) by, for example, executing software, that determines which offer to select. For example, the server system 125 might accept the offer from entity B (step 1675) and reject the offer from entity C (step 1680). The server system 125 then confirms the transaction with the sending system 110 (step 1685). In another implementation, the sending system 110, rather than the server system 125, selects the offer and issues the notices of acceptance and rejection.

Other implementations of the electronic parcel delivery system 100 can combine the various features shown in FIGS. 14, 15A, 15B, 16A and 16B and discussed above.

Integration with Other Delivery Mechanisms

Referring again to FIG. 1, the electronic parcel delivery system 100 can cooperate with other parcel delivery mechanisms. For example, the server system 125 can print a copy of the parcel received from the sending system 110. Rather than transmit the parcel to the receiving system 115 over the network 105, the server system 125 can fax the parcel to the receiving system 110. In another implementation, the server system 125 prints a copy of the parcel on a printer and sends the printed copy through a carrier service.

Hybrid Electronic Mail and Electronic Parcel Delivery System

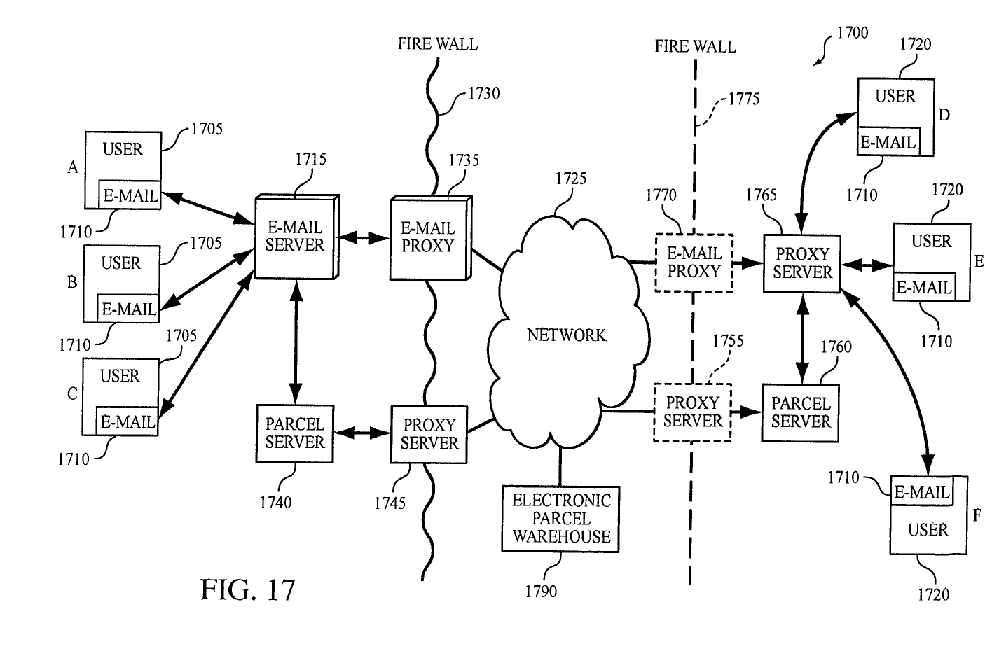

Referring to FIG. 17, a hybrid system 1700 integrates a parcel delivery system, such as the system 100 described above, with a standard electronic mail (e-mail) system. In general, the hybrid system 1700 redirects relatively large transmissions from a standard email system to a parcel delivery system, such that the hybrid system is capable of handling larger transmissions than a standard e-mail system. The system 1700 provides a user with a standard e-mail user interface, while still providing the advantages of a parcel delivery system. In addition, by using a standard e-mail system, the user only needs to maintain a single set of contacts and mailing lists.

In the hybrid system 1700, each of one or more local network users 1705 runs an email program 1710, such as MICROSOFT OUTLOOK™, on a local system. The e-mail program 1710 presents a standard user interface. The interface is generally a graphical user interface (GUI), such that a user familiar with the e-mail program 1710 does not need to learn a new interface in order to interact with the hybrid system 1700. However, other interfaces may be used to replace or augment the standard e-mail interface, e.g., parallel/serial/other data ports capable of receiving propagated signals carrying the electronic data.

An e-mail server 1715 communicates with the e-mail program 1710 to coordinate transmission and receipt of messages and other items. For purposes of this discussion, messages and other items are classified as local messages, other local items, remote messages, and remote parcels. Local messages and other local items are transmitted between users of the same e-mail server 1715 (e.g., between a first user 1705 (user A) and a second user 1705 (user B)). Remote messages are messages transmitted between users of different e-mail servers (e.g., between a local user 1705 (user A) and a remote user 1720 (user D)). Remote parcels are items transmitted to remote users 1720 through the parcel delivery system.

The e-mail server 1715 passes local messages and other local items between local users 1710. The e-mail server 1715 also directs remote messages to remote users 1720 over a network 1725, such as the Internet. In some implementations, a firewall 1730 isolates the e-mail server 1715 from the network 1725, and an e-mail proxy server 1735 is used to coordinate communications between the e-mail server 1715 and the network 1725. For some implementations, each different type of e-mail program 1710 may communicate with a different e-mail server 1715.

The e-mail server 1715 identifies remote parcels to be transmitted using the parcel delivery system, and transmits the identified remote parcels to a local parcel server 1740. The users may affirmatively designate messages or other items to be transmitted using the parcel delivery system. As an alternative, or in addition, the e-mail server 1715 may automatically direct items to the local parcel server 1740 using criteria such as file size and security indications. Rules may be established to identify items appropriate for delivery using the parcel delivery system, e.g., to direct traffic based on parcel characteristics.

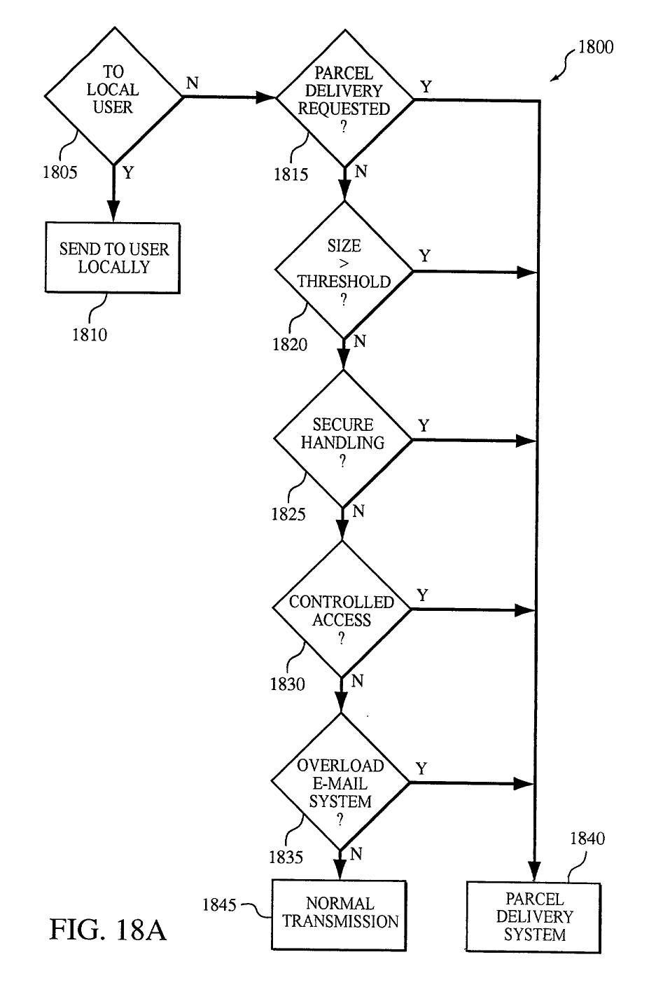

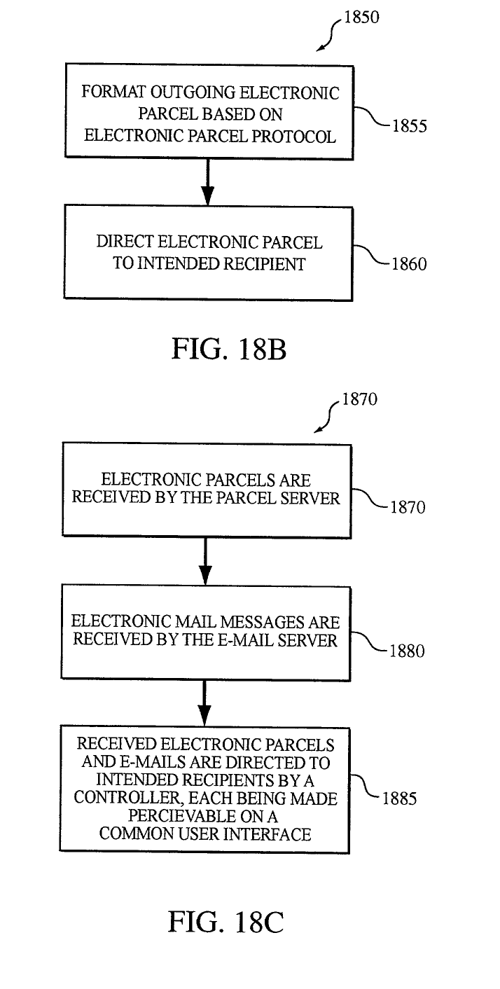

Referring to FIG. 18A, in one implementation, the e-mail server 1715 processes outgoing items according to a procedure 1800. Initially, the server 1715 determines whether an item to be communicated is directed to a local user 1705 (step 1805). If so, the server 1715 directs the item to the appropriate local user 1705 (step 1810). For communications not directed to local users (step 1805), the server 1715 determines whether the sending user 1705 has indicated that the parcel delivery system is to be used (step 1815), whether the size of the item being communicated exceeds a predetermined size threshold level (step 1820), whether the sending user 1705 has indicated that the item is sensitive or that it otherwise requires secure handling (step 1825), whether the sending user 1705 has indicated that the item requires controlled access (step 1830), and whether the item will overload the e-mail server 1715 (step 1835). If any of these conditions exist, or if the e-mail server 1715 otherwise determines that the item is to be delivered using the parcel delivery system, the e-mail server 1715 directs the item being communicated to the local parcel server 1740 for transmission using the parcel delivery system (step 1840). Otherwise, the e-mail server 1715 directs the item being communicated to the e-mail proxy server 1735 for normal e-mail transmission (step 1845).

The document delivery system has encryption and other controlled-access capabilities that make it particularly useful for sensitive communications and the like. Examples of the controlled access capabilities of the document delivery system may include the provision of detailed sender monitoring with regard to the status of the communication (e.g., delivered to or read by the intended recipient), as well as limitations on the recipient's ability to save, copy, or print the communication, and sender monitoring of which of those acts has been performed.

The local parcel server 1740 functions in much the same way as the client parcel software of the sending system (e.g., sending system 110) of the document delivery system 100 described above with respect to FIG. 1. In one implementation, the system operates according to the procedure 1850 illustrated in FIG. 18B. First, local parcel server 1740 formats outgoing electronic parcels based on an electronic parcel protocol that differs from the standard electronic mail protocol used by e-mail server 1715 to format outgoing e-mail messages (step 1855). The electronic parcel and electronic mail protocols may differ with respect to an allowable maximum size for electronic parcels and mail messages, or they may differ with respect to other or additional criteria. For instance, to enable communications of large electronic parcels, the electronic parcel protocol may allow for a maximum parcel size that exceeds the maximum electronic mail message size permitted by the electronic mail protocol. Once an outgoing electronic parcel is formatted in accordance with the electronic parcel protocol, local parcel server 1740 directs the outgoing electronic parcel to the intended recipient by, for example, transmitting that parcel to an electronic parcel warehouse 1750 over the network 1725 (step 1860). In one implementation involving the use of a firewall 1730, local parcel server 1710 uses a proxy server 1745 to communicate over the network 1725. However, in the absence of the firewall 1730, proxy server 1745 may or may not be used.

The parcel warehouse 1750 functions in much the same way as the server (e.g., server 125) of the document delivery system described above. In particular, the parcel warehouse 1750 communicates with a remote parcel server 1760 to deliver items to the remote parcel server 1760 and ultimately to remote users 1720 through remote e-mail server 1765.

As illustrated using broken lines, in one implementation involving the use of a firewall 1775 by the remote system, communications between the network 1725 and remote e-mail server 1765 may be through an e-mail proxy server 1770 in much the same way that communications between the network 1725 and e-mail server 1715 were through e-mail proxy server 1735, and communications between electronic parcel warehouse 1750 and parcel server 1760 may be through proxy server 1755 in much the same way that communications between electronic parcel warehouse 1750 and parcel server 1740 were through proxy server 1745.

The remote parcel server 1760 includes software that functions in much the same way as the client software of the receiving system (e.g., receiving system 115) of the document delivery system described above. Upon receiving a communication, the remote parcel server 1760 forwards the communication to a remote e-mail server 1765 for delivery to an appropriate user 1720. The user 1720 receives the communication as if it were an e-mail message sent using the normal e-mail messaging channel, and makes the received communication available on a standard user interface of the hybrid system. This interface is also used to make e-mail communications available to the recipient, and may be implemented, for example, as a common graphical user interface. Thus, the hybrid system 1700 provides seamless operation that is essentially transparent to the users 1710 and 1720.

As shown by the process 1870 of FIG. 18C, according to one implementation, parcel server 1760 receives communications including electronic parcels that are directed to users D, E, and F 1720 (step 1875). These communications are formatted according to the electronic parcel protocol. Parcel server 1760 directs received electronic parcels to e-mail server 1765. Similarly, electronic mail messages formatted based on the electronic mail protocol is received by e-mail server 1765 (step 1880). E-mail server 1765 may then operate as a controller to direct received electronic parcels and electronic mail to a common user interface (e.g., a graphical user interface ordinarily integrated into an e-mail system) at the appropriate user 1720 (step 1885).

Accordingly, the electronic parcel delivery system is able to send and receive electronic parcels, even if they do not conform with electronic mail protocols. Furthermore, the electronic mail may be delivered using a channel that does not include electronic parcel delivery servers.

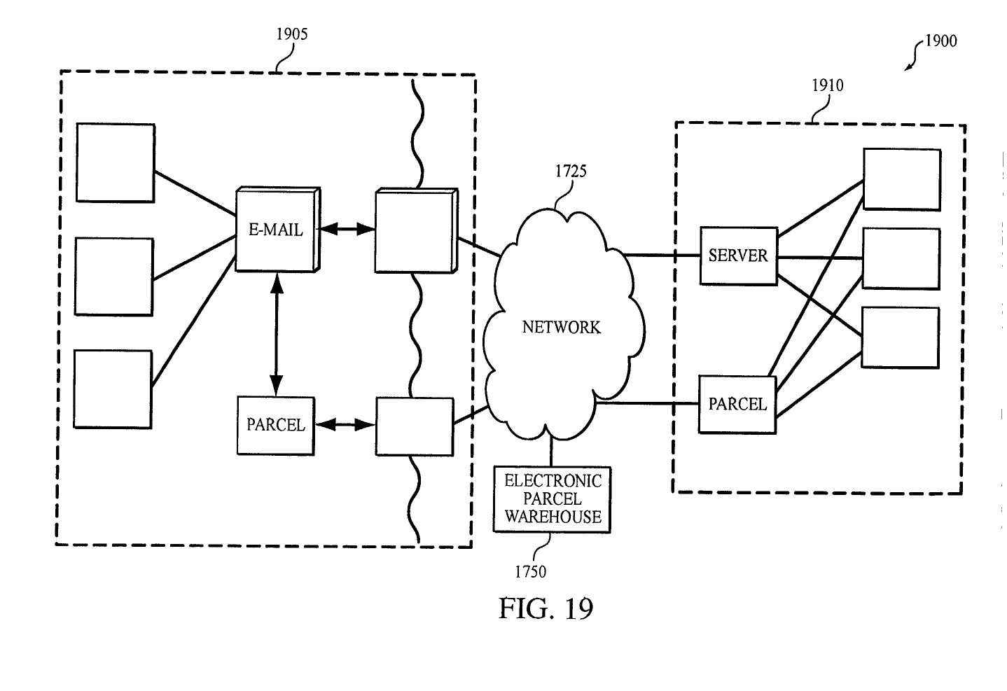

Referring to FIG. 19, in an alternative hybrid system 1900, one site 1905 may employ a hybrid system while another site 1910 employs isolated e-mail and document delivery systems with either site being capable of sending and/or receiving communications. At the site 1905, all communications are transmitted and received through the common user interface as described above. At the site 1910, normal e-mail messages are transmitted and received using an e-mail interface, while parcels delivered using the parcel delivery system are transmitted and received using an interface of the parcel delivery system. Combinations of the hybrid systems 1700 and 1900 may also be used.

Both of the systems 1700, 1900 may use event-based e-mail messages to notify users of the status of communications. For example, when the e-mail server 1715 transfers a parcel to the local parcel server 1740, the e-mail server 1715 may send an e-mail message to the intended recipient indicating that the parcel is coming. Similarly, when the remote e-mail server 1760 receives a parcel from the remote parcel server 1755, it may send an e-mail message to the sender indicating that the parcel has been received. The e-mail server 1760 may also send messages to the sender indicating whether the parcel is opened, moved, read, deleted, or printed. In the event that a parcel is not delivered, e-mail messages may be sent to the sender, the intended recipient, or both.

Deployment System

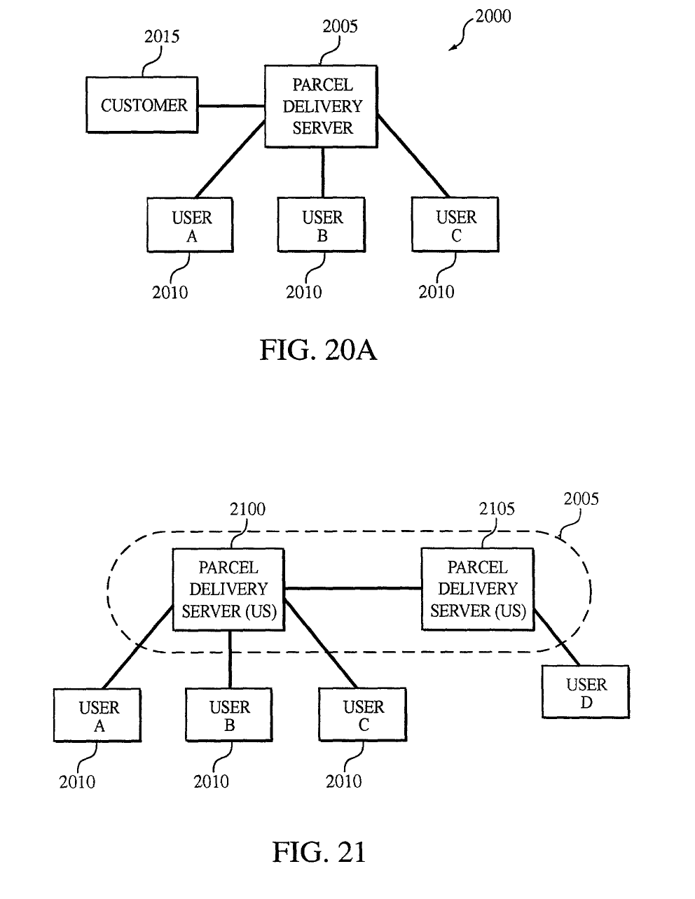

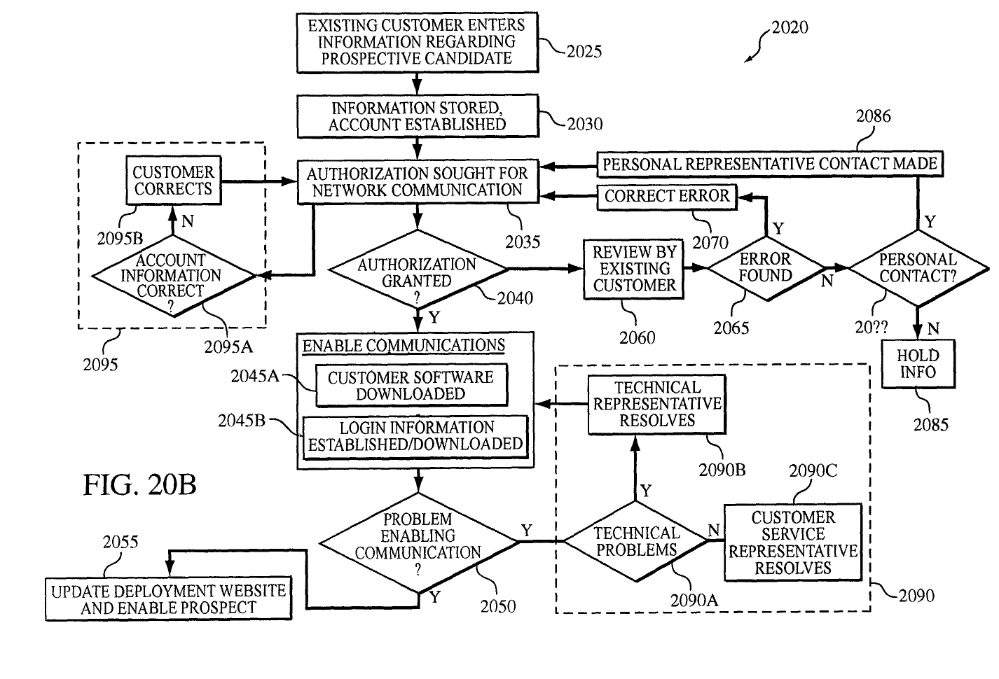

FIGS. 20A and 20B illustrate an exemplary implementation of a deployment system employed in conjunction with an electronic parcel delivery system or a hybrid electronic mail and electronic parcel delivery system as described herein.

Referring to FIG. 20A, either system may be deployed rapidly to form a virtual private network 2000. The network 2000 is a secure, client-defined communications network that uses a parcel delivery server 2005 (e.g., server system 125 or electronic parcel warehouse 1750) as its central hub.

The communications over the network 2000, between the server 2005 and users 2010 or between users 2010 themselves, are secured by public/private key pairs. Thus, for example, communications with a first user 2010 (user A) are protected by a first public/private key pair, while communications with a second user 2010 (user B) are protected by a second public/private key pair.

Users 2010 of the network 2000 may have certificate-based identities, in which each user 2010 is identified by a certificate which is generally a downloaded file, and an associated password. This is in contrast to traditional identification approaches in which a network user is identified by a user name and a password. In general, a user's certificate contains the user's digital public/private keys, server connection information, a user identification, and an indication of certificate authority. In systems such as the hybrid system 1700 described above, a parcel server or group of parcel servers (e.g., one or more local parcel servers 1740) can constitute a “user” that provides access to one or more other users, such that individual users are not required to have their own certificates.

In the network 2000, the server 2005 provides centrally-managed certificates to enable secure communications with each user 2010. Under this approach, a particular user 2010 only needs to know its own public key to enable communication with the server 2005 and thus to enable communications with other users 2010 that also communicate with the server 2005. Because communications are made through server 2005, users 2010 individually need not to know the public keys of other users 2010 in order to communicate with those users 2010, eliminating the need for an exchange of public keys otherwise required to enable communications between users 2010.

Therefore, the protocol provides for a first secure communication between a transmitting user 2010 and server 2005 based on a first public key shared therebetween, and for a second secure communication between the server 2005 and a recipient user 2010 based on a second public key shared therebetween.

The network 2000 may be implemented and used to permit a user 2010 to make secure data connections to a large number of other users 2010 in minimal time and with minimal traffic. For example, in some implementations, a user 2010 can be added to the network in fifteen minutes or less, with multiple users being added simultaneously. In general, the addition of a user 2010 only requires the user 2010 to install the client parcel software and to install a certificate corresponding to the public/private key pair for the user 2010. However, in another implementation involving centralized processing at the server 2005, even the installation of client software may be unnecessary.

The client parcel software works through firewalls, enabling its installation on virtually any machine. Both the client parcel software and the certificate can be downloaded from a network, such that the installation can proceed completely electronically. For example, in some implementations, the installation can be initiated with a single click of a prospective user's mouse, and can be completed entirely automatically such that only the single mouse click is required to complete the installation.

Referring to FIG. 20B, one implementation of the system 2000 achieves deployment according to a procedure 2020. To take advantage of the deployment system 2000 described above, identification and/or contact information (e.g., name, electronic mail and physical address, telephone number, facsimile number, and employer name and address) for one or more prospective deployment candidates may be obtained using an electronic interface (step 2025). The electronic interface may be a graphical or other user interface that is accessible by a user. For instance, the electronic interface may be with a network such as the Internet, with a parallel, serial or other type of data port, or with any other system or device capable of receiving propagated signals carrying electrical information. The identification information may be temporarily or permanently stored, and an account may be automatically created by the parcel delivery server 2005 for each of the prospective candidates (step 2030).

Authorization is subsequently sought from each prospective deployment candidate to add that candidate to the communications network so as to enable secure communications between that candidate and the customer (step 2035). Authorization may be generally sought by automatically sending an e-mail request based on the identification information provided by the customer, which generally includes at least an e-mail address. However, other forms of requests are also feasible, such as telephone calls, facsimile and standard letters. The authorization request may be a general request to add the candidates to the network, or it may be more detailed request (e.g., listing information about the candidates for their review and/or requesting to configure a candidate's computer to enable communications of electronic parcels with the candidate or other existing and/or prospective members of the network).

When more detailed information is provided with the authorization request in step 2035, the prospective deployment candidate may be given an opportunity to amend that information (step 2095). For instance, if errors are determined to exist within data defining the newly created account (step 2095A), a prospective deployment candidate may be given an opportunity to provide corrective data (step 2095B). Prospective deployment candidates may be shown their account information repeatedly after each correction or series of several corrections to provide them an opportunity to again review newly-added or changed information in their account, to identify additional or remaining errors in their account information, and to correct such errors (steps 2035 and 2095).

When authorization for the new account is received from the prospective deployment candidate (step 2040), the candidate is added to the network and communications are enabled (step 2045). In the implementation shown, customer software and login information are automatically downloaded and installed on the computer of the new user to enable future and secure access to the new user's account (step 2045). As described previously, the login information for an account generally includes public/private key pairs, such that a certificate is created and downloaded. As an alternative, it is possible for electronic parcel communications to be enabled by downloading only the login information, relying on centralized client software (e.g., at the server) to provide the requisite functionality, as shown in step 2045B.

After communications have been enabled, the deployment Web site is updated with the new account information so as to enable the customer to begin transactions with the newly-added user (step 2055).

When authorization for the new account is not received from the prospective deployment candidate (step 2040), a request is sent to the customer 2015 to review the account information stored regarding the prospective deployment candidate (step 2060). If an error exists in the contact information or other account information (step 2065), the customer 2015 is able to correct and update the account (step 2070) such that authorization may be again requested of the prospective deployment candidate (step 2035). By contrast, if the contact and account information is deemed acceptable (step 2065), a determination can be made as to whether personal contact with the prospective deployment candidate is appropriate (step 2075). When appropriate, personal contact is attempted (step 2080). When not appropriate, the account information may be held for future use (step 2085). Personal contact is generally deemed appropriate when the prospective deployment candidate has been contacted only by electronic means.

Problems may be experienced while attempting to enable communications. When problems are experienced (step 2050), a procedure 2090 is performed to resolve such problems. If problems are technical in nature (step 2090A), they are generally directed to technical representatives for resolution (step 2090B), and a subsequent attempt is made to enable communications (step 2045). By contrast, if problems are not technical in nature (step 2090A), the prospective deployment candidate may be contacted by a customer service representative to resolve problems (step 2090C).

Although not shown in FIG. 20B, when a firewall is used, proxy information may be determined and loaded on the systems of account holders. A more detailed description of techniques available for determining proxy information is provided with respect to FIG. 13.

In an alternative implementation that is illustrated in FIG. 21, server 2005 may be globally distributed while still providing a single, contiguous service. For example, the server 2005 could include a first server portion 2100 located in the United States and a second server portion 2105 located in Japan.

Premium Components

Systems such as the electronic parcel delivery service 100 and the hybrid system 1700 may be enhanced through the addition of premium components. The premium components may be in the form of modules that are easily (and automatically) incorporated in the client parcel software and may be downloaded along with the client parcel software, or at a later date or time. Examples of premium component modules include a receive automation module, a send automation module, a notification module, and a copy protection module.

The receive automation module provides for automatic processing of received communications including mail and parcels. The receive automation module uses sophisticated filtering techniques to pass received data to programs or scripts for post-delivery data processing. Different filtering parameters may include, for example, the identity of the parcel's sender, the description of the parcel, and the time at which the parcel is sent. In one particular example, the receive automation module can be used to incorporate data files enclosed in parcels from several sources into a single, combined data file, to generate a report using an application program that processes the combined data file, to incorporate the generated report into a parcel, and to send the parcel to a list of recipients. The send automation module works similarly to the receive automation module. The send automation module may be used, for example, to automatically send a group of files to a list of recipients at a specified time. For example, the send automation module could be used to send, on an hourly basis, all files from a particular folder or directory that have been edited or created within the previous hour.

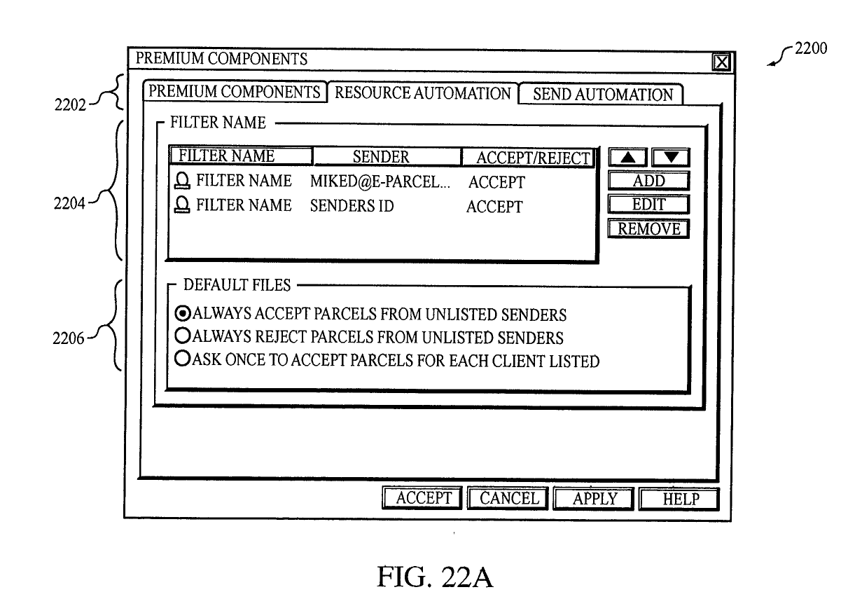

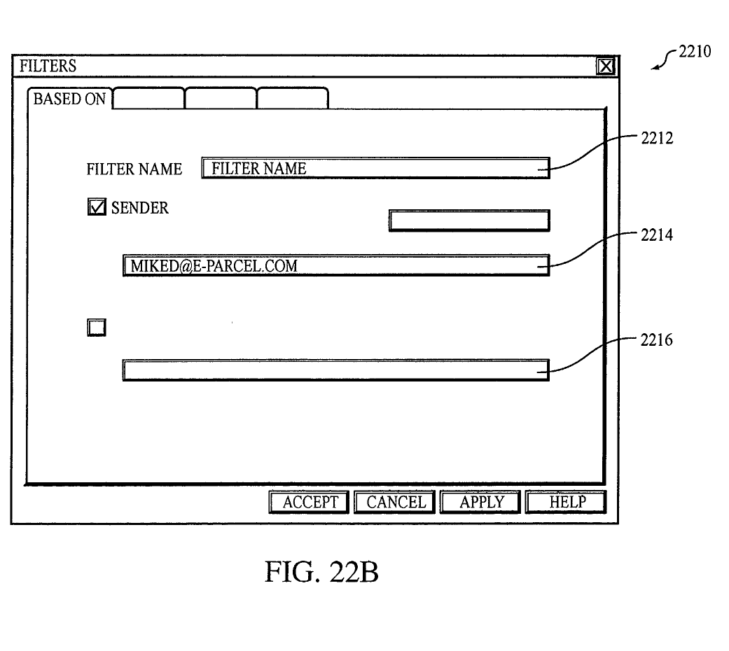

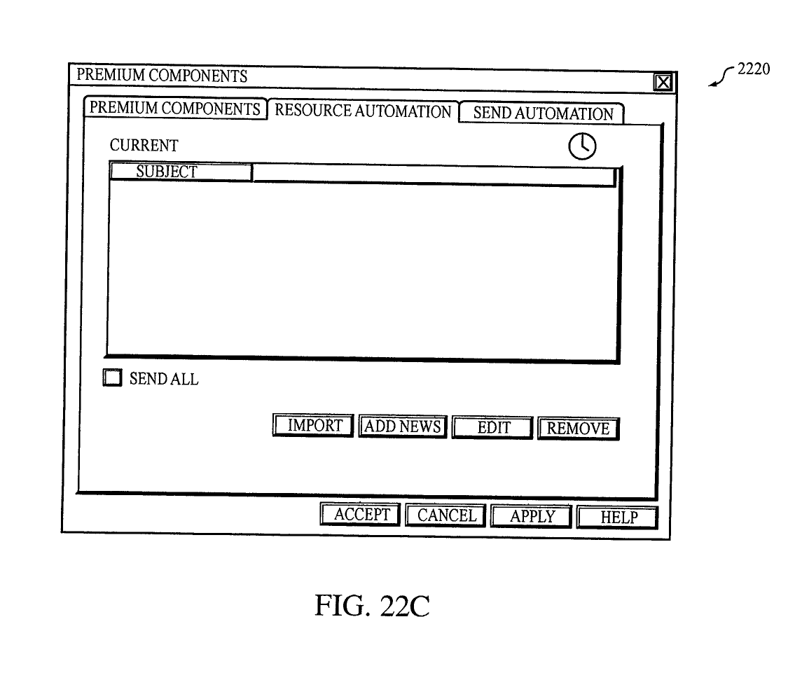

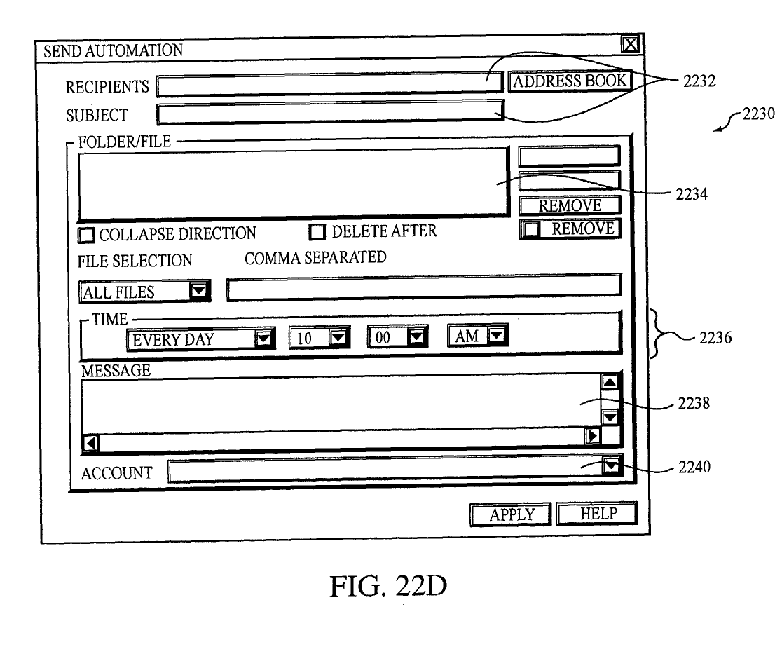

FIGS. 22A-22D illustrate exemplary graphical user interfaces useful in enabling send and receive automation modules having characteristics as described above, FIGS. 22A and 22C illustrate exemplary graphical user interfaces 2200 and 2220 including interactive selectable buttons 2202 for enabling at least the receive automation module and the send automation module.

Referring to FIG. 22A, an example of a graphical user interface 2200 for the receive automation module permits a user to designate one or more software programs for automatically processing received documents. For instance, in the particular example illustrated in FIG. 22A, an automatic filtering process is made available to the customer, and the customer is allowed to specify conditions for accepting and rejecting documents from selected senders. For instance, as illustrated in area 2204, a user may list one or more senders along with associated filtering information and filtering status.

Filtering information may indicate the software used to perform the filtering function. FIG. 22B illustrates an exemplary graphical user interface 2210 useful in specifying filter information. As illustrated, it is possible to identify a software filter by name 2212, and to apply that filter to parcels received from one or more senders 2214 or parcels directed to one or more subjects 2216.

Filtering status indicates how to handle parcels received from the corresponding sender (e.g., to accept or reject parcels). A default filtering status 2206 may also be used to specify one of several default rules to be applied to senders for which filtering is not otherwise specified. Although countless other default states may be used, three are illustrated in FIG. 22A, namely (1) always accept parcels from unlisted senders, (2) always reject parcels from unlisted senders, and (3) ask once to accept or reject parcels from each unlisted sender.

Referring to FIG. 22C, an example of a graphical user interface 2220 for the send automation module permits a user to designate one or more deliveries to be automatically initiated at a specified time. FIG. 22D illustrates a graphical user interface 2230 useful in entering information when designating deliveries to be automated by the send automation module. For instance, information solicited by this graphical user interface 2230 includes identifiers for the recipient and/or subject 2232, the location of folders/files to be sent 2234, the time for delivery 2236, message information to accompany the delivery 2238, and account information for billing purposes and the like 2240. Delivery time may include periodic deliveries.

The notification module provides automatic notification of a variety of events associated with an electronic communication. For example, as noted above, a sender may receive e-mails when a parcel is received, opened, moved, read, deleted, processed, or printed. Similarly, a recipient may receive an e-mail noting that a parcel is coming when the parcel is transmitted. In the event that a parcel is not delivered, e-mail messages may be sent to the sender, the intended recipient, or both.

The copy protection module provides a sender with the ability to control a recipient's access to the contents of a parcel. For example, the sender can use the copy protection module to prevent a recipient from printing or copying the contents of a parcel. Techniques for controlling access to the contents of transmitted parcels are described in U.S Application Ser. No. 09/281,894, titled “Method And Apparatus For Protecting Documents From Unauthorized Copying And Distributing Of Electronic Messages Transmitted Over A Network” and filed Mar. 31, 1999, which is incorporated by reference.

Multi-User Account System

The hybrid document and parcel delivery system described above may be configured to support use by groups of multiple users associated with a common account and login information. From a management perspective, such a configuration enables features such as centralized billing and account management. From the client's and/or the user's perspective, this configuration enables features such as centralized document handling.

A multi-user account is established based on various criteria including general identification information, account characteristics, and/or user lists. General identification information may include login information and/or contact information. Login information typically includes an account login name (e.g., screen name) and/or password information. Contact information generally includes a company and/or account representative's name, an address (e.g., physical and/or electronic), and/or a telephone number.

Account characteristics generally include billing information and information regarding limits (e.g., usage limits) placed on the account.

One or more user lists may be established for each account. Users are added to an account in much the same way that users are added to the deployment lists, as discussed above with respect to FIGS. 20A and 20B. For instance, the users may be added by entering identifying information and by creating login information including passwords or certifications. Users may be listed on more than one account, each account sharing identification information but maintaining unique login information for the user. A single user may be listed on one or more accounts.

Once established, an account can be updated and/or edited by any user having the account identification and login information. Additionally, users of an account may access information concerning their individual user name using a user-specified identification code. In this way, the general account becomes transparent to individual users therein.

Converting Standard E-Mail Packages to Hybrid Systems

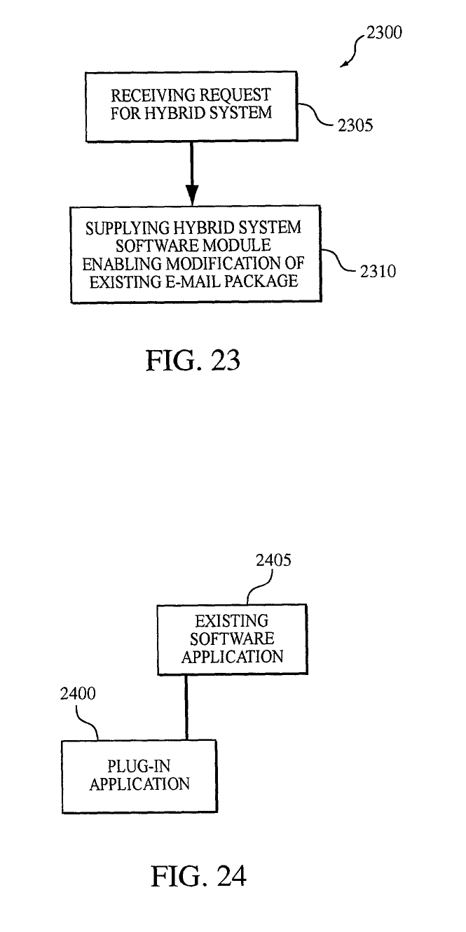

Referring to FIG. 23, the hybrid electronic mail and electronic delivery system 1700 may be implemented by modifying an existing e-mail system according to a procedure 2300. Initially, a request for a hybrid system is received (step 2305). A request may be an explicit request made by a prospective user (by telephone, facsimile, e-mail, or otherwise), or a request may be a virtual request generated based on information gathered for one or more perspective users that indicates a desirability for the hybrid system on the part of the perspective users (e.g., information-based marketing information).

In response to such a request, a hybrid system module that is capable of modifying a previously-installed electronic mail system is supplied so as to cause a previously-installed electronic mail system to function in the manner described above (step 2310). Alternatively, although not shown in FIG. 23, in response to a request for a hybrid system, a standalone hybrid system module that does not require modification of an existing e-mail system may be provided. Such a standalone hybrid system module can be loaded on computer systems having no e-mail capabilities to provide the functionality described herein.

Plug-in Application

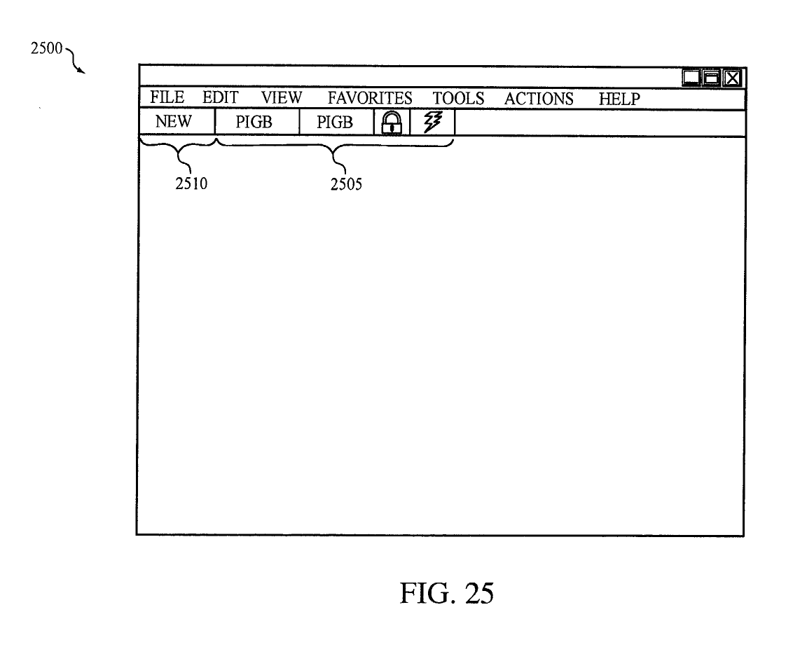

In another implementation, as shown in FIG. 24, the application software (e.g., the client parcel software) can take the form of a plug-in application 2400. The plug-in application 2400 may be installed on the sending system 110 (and also the receiving system 115) and can be integrated with an existing software application 2405, such that, for example, graphical user interfaces of, the existing software application are modified to incorporate features of the plug-in application. This integration may be perceived by the user to be a natural addition/extension of the graphical user interface 2500 of the existing software application 2405, as shown in FIG. 25, or the integration may use graphical/visual techniques to accentuate the graphical/visual features of the plug-in application 2400. For example, as shown in FIG. 25, the plug-in application features may take the form of plug-in graphical buttons 2505. These plug-in graphical buttons 2505 may resemble existing graphical buttons 2510 of the existing software application 2405, or may be accentuated (e.g., in a different color or geometric design) to distinguish the plug-in graphical buttons 2505 from the existing graphical buttons 2510.

Further, the plug-in application 2400 can be integrated with existing software applications 2405 to work seamlessly on a software (e.g., machine-language) level. By way of example, the existing software applications may be common information management applications (including electronic mail management programs) such as, for example, Microsoft® Outlook® and Lotus® Notes.

Similar to the implementations described above, the electronic parcel, or digital content (e.g., electronic mail message, video, audio, or text files), may be compressed and/or encrypted by the plug-in application 2400 in real time, possibly even while transmitting the digital content. The encrypted digital content will travel over secured communication paths between the sending system 110, the server system 125, and the receiving system 115. Finally, the encrypted digital content, once received at the receiving system 115, may be decrypted and decompressed, provided the user follows the implemented procedure for opening the digital content sent using the plug-in application 2400 as described below.

Moreover, the plug-in application 2400 may allow digital content of any size (e.g., large size movie files) to be encrypted and distributed to recipients.

According to this implementation, the user (e.g., sender) may select between a secured, digital rights management system or a normal, unsecured system for delivery of the user's digital content. This is distinguishable from some of the systems described above, in that the user is given a side-by-side option to choose between the secured system and the unsecured system. The user may never realize that the secured system is entirely different from the normal, existing software application systems.

In one implementation, the rights management features of the plug-in application may include one or more of the following features, as well as one or more of the features noted above. The plug-in application may provide digital asset control features that dictate what rights the recipient may have to manipulate the digital content once that content is received. These digital asset control features may be selected at the time the sender is preparing to send the digital content using the plug-in application 2400. The sender may be able to control manipulation of the digital content (e.g., electronic mail message, video, audio, or text files). For example, the sender may be able to control forwarding, copying, printing, duration of manipulation, and a number of times the digital content may be manipulated. Further, the sender may specify that the digital content is to be “shredded” (i.e., completely erased from the receiving system 115 using techniques such as, for example, a deletion algorithm that writes over the digital content enough times (e.g., 8 to 9) that the digital content cannot be recovered from the receiving system 115 even through the use of sophisticated techniques) once the rights in the digital content have expired. Shredding can be implemented by, for example, providing an “autoshred” selection option when the sender is preparing to send the digital content using the plug-in application 2400.

Additionally, the plug-in application 2400 may include one or more of the following tracking features, as well as one or more of the features noted above. The plug-in application may provide user interface features that allow the sender to track what is being done with the digital content. For example, the tracking features may include information such as when/how the digital content was received, viewed, destroyed (e.g., shredded), and if the digital content was manipulated in any other way and by whom. Further, the tracking feature may provide delivery status such as, for example, the date and time that the delivery of the digital content parcel commenced and finished, when/if the recipient was confirmed as a valid registered recipient, and when the digital content parcel was opened.

Another advantage that may be realized by using the plug-in application 2400 is that digital content is securely distributed using secured channels, without storing-and-forwarding the encrypted digital content on any intermediate storage device, except when the digital content is undeliverable. However, once the digital content is deliverable, any intermediate server may deliver the digital content and erase all copies of the digital content. This feature is quite different from, for example, the techniques used by normal store-and-forward public key infrastructure (PKI) systems. Essentially, the plug-in application 2400 can allow encrypted digital content to be sent over secured channels, while still controlling exactly how many copies are in existence (since no copy is made at any distribution server, and the digital asset control features described above can control the rights the recipient has with respect to the digital content).

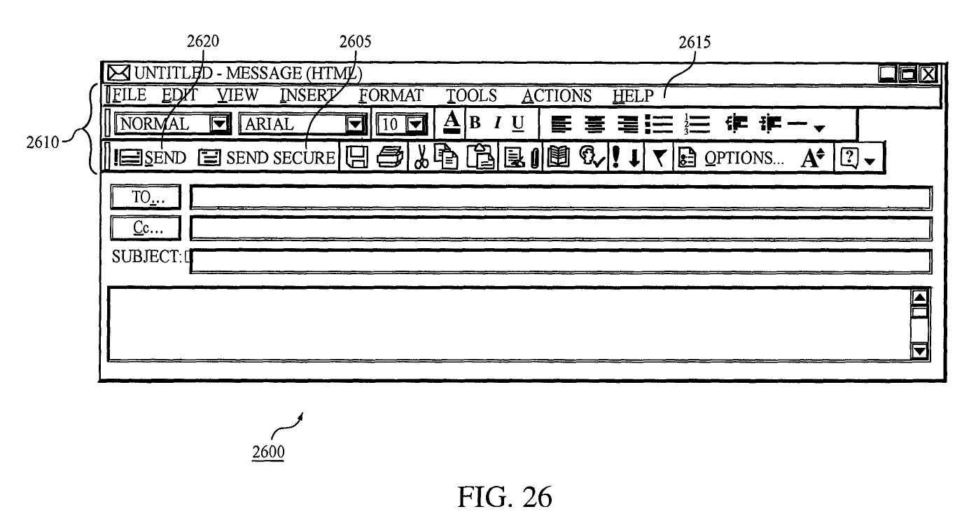

Turning now to FIG. 26 and regarding the features of the graphical user interface 2600 perceived by the user (sender and/or recipient), the plug-in application 2400 may include one or more of the following features, as well as one or more of the features noted above. On the sending side, the plug-in application 2400 may modify the graphical user interface 2600 of the existing software application 2405 so that the sender may encounter the features shown in FIG. 26. For example, with Microsoft® Outlook® as the existing software application 2405, the sender's display screen may include a “Send Secure” button 2605 in the toolbar area 2610 of the message creation window 2615, for example, next to the normal “Send” button 2620. The “Send Secure” button 2605 may be visually similar in color and styling to blend in with the graphical user interface 2600 of the existing software application 2405. Alternatively, the plug-in buttons (e.g., “Send Secure” button 2605) can be conspicuously displayed so that they stand out from the graphical user interface 2600 of the existing software application 2405. Moreover, the plug-in application 2400 may feature iconic buttons, instead of text-labeled buttons.

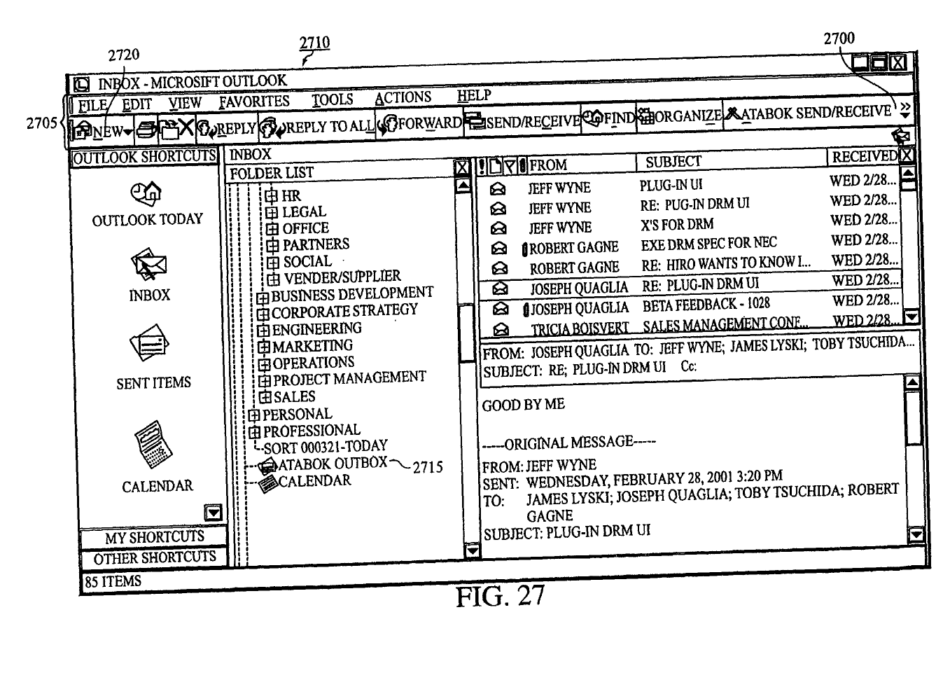

Other modifications to the graphical user interface 2600 of the existing software application 2405 may include an “Autoshred” button in the toolbar area 2610 in the message creation window 2615 or in a separate popup window, as discussed below. Further, a “Send/Receive” (or “Check Now”) button 2700 may be included in the main screen toolbar 2705 as shown in FIG. 27. This “Send/Receive” button 2700 can allow a user to access the send and receive features of the plug-in application 2400 from the normal main screen graphical user interface 2710 of the existing software application 2405.

Additionally, the toolbar area 2610 in the message creation window 2615 (or in a separate popup window) may include graphical buttons such as, for example, a “Recall” button for recalling the particular copy or type of digital content after it has been sent, a “Chain Letter” button that allows recipients to manipulate the digital content and forward it to another recipient, a “Prevent Chain Letter” button that prevents the digital content from being manipulated on any computer device other than the particular receiving system 115 to which the digital content is sent, and a “No Copy” button which prevents copies of the digital content from being made by the recipient.

Additionally, the normal main screen graphical user interface 2710 may include a separate plug-in application “outbox” folder 2715, as shown in FIG. 27. This outbox folder 2715 can allow the user to view all of the digital content parcels/messages sent using the plug-in application 2400.

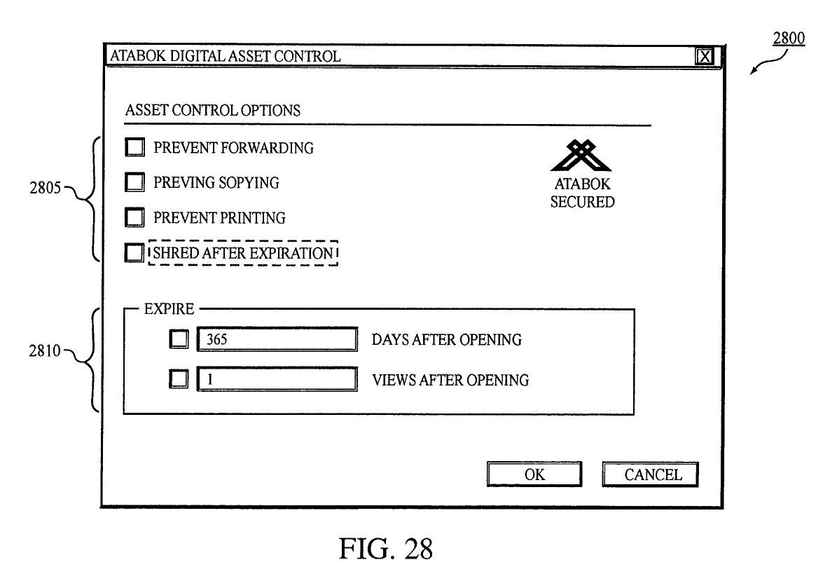

In one implementation, when a user wishes to send digital content using the plug-in application 2400, the user double-clicks the “New” button 2720 in the main screen toolbar 2705 shown in FIG. 27. This causes the message creation window 2615 to appear, as shown in FIG. 26. Using the message creation window 2615, the user may create or attaches the digital content to be sent using the plug-in application 2400. To send the digital content using the plug-in application 2400, the user clicks on the “Send Secure” button 2605, which causes the digital asset control popup window 2800 shown in FIG. 28 to appear. This window allows the sender to select the rights the recipient will have to manipulate the digital content.

The digital asset control window 2800 (which may alternatively be implemented by, for example, an option menu, or toolbar buttons displayed in the message header) may include selectable option boxes 2805 that allow the sender to control, for example, whether the digital content will be shredded after expiration, and the ways in which the recipient is permitted to manipulate (e.g., forward, copy, and print) the digital content. Further, the digital asset control window 2800 may include input areas 2810 that allow the sender to specify, for example, how many times the digital content may be viewed by the recipient and when the digital content will expire.

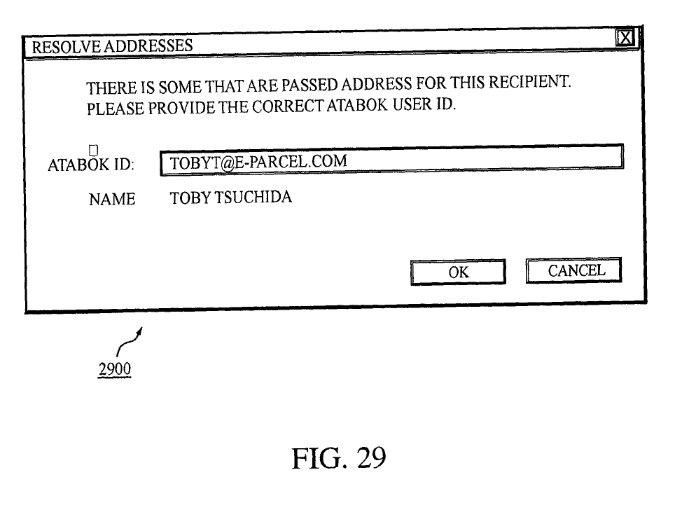

FIG. 29 shows a resolve addresses popup window 2900 that provides another feature that may be included in the sending process is shown in FIG. 29. The resolve addresses popup window 2900 may appear if more than one address exists for the recipient, and allows the sender to specify the correct address to which the digital content should be sent. Further, the window 2900 may notify the sender that the specified recipient is not a registered user, and that the digital content cannot be sent to an unregistered recipient.

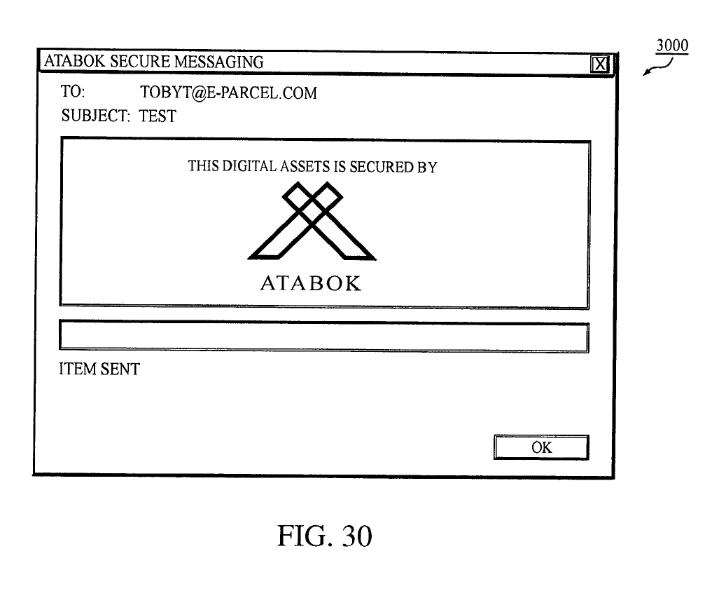

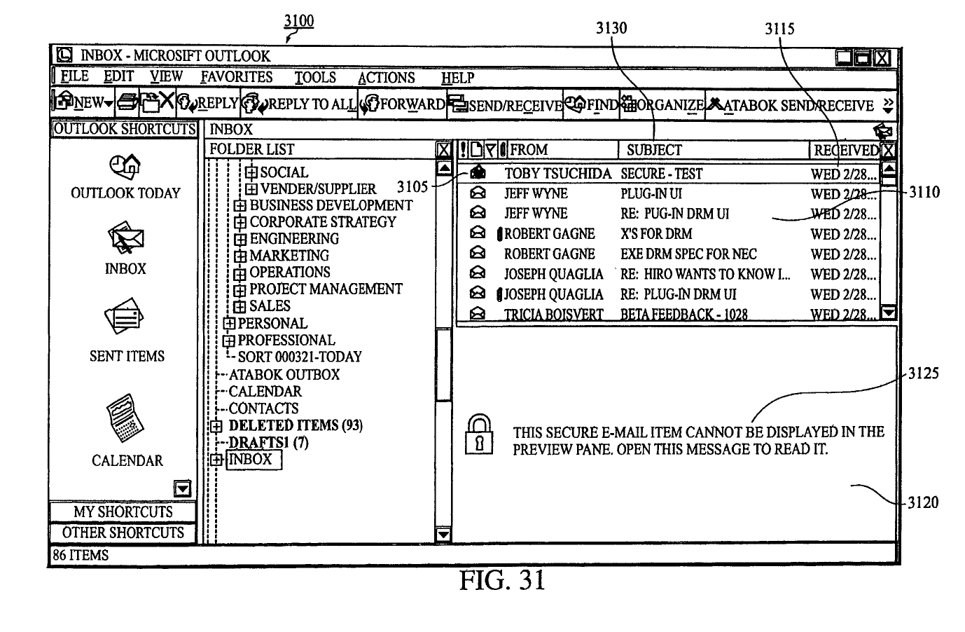

Once the digital content is ready to be sent and the sending options have been specified, the user may click on the “okay” button of the last popup window, for example, the digital asset control popup window 2800 or the resolve addresses popup window 2900, and the digital content may automatically be sent by the plug-in application 2400. While the digital content is being sent (e.g., encrypted, compressed, and sent using a secure communication channel to the server system 125), the plug-in application 2400 may cause a progress popup window 3000 to appear, as shown in FIG. 30, which allows the user to monitor the sending status of the digital content.

An implementation of the receiving side graphical user interface 3100, including several features of the plug-in application 2400, is shown in FIG. 31. The graphically-implemented features of the plug-in application 2400 may include a supplemented icon 3105 in the message inbox pane 3110 for the particular message listing 3115, such as, for example, an icon of an envelope overlaid by an icon of a padlock to indicate that the particular message is secure. The addition of the padlock icon to the standard icon (e.g., envelope) of the existing software application 2405 distinguishes regular messages sent/received by normal methods used by the existing software application 2405 from messages sent/received by the procedures implemented by the plug-in application 2400.

Further, when the particular message listing 3115 is selected/highlighted, a message preview pane 3120 may display a security message 3125 instead of displaying a portion of the actual message. In other words, the normal function of a preview pane 3120 in, for example, Microsoft® Outlook®, is to show a portion of the message corresponding to the particular message listing 3115. However, the plug-in application 2400 may cause the preview pane 3120 to keep hidden the contents of the message and instead display a security message 3125 such as “This secure e-mail item cannot be displayed in the Preview Pane. Please open the message to read it.”

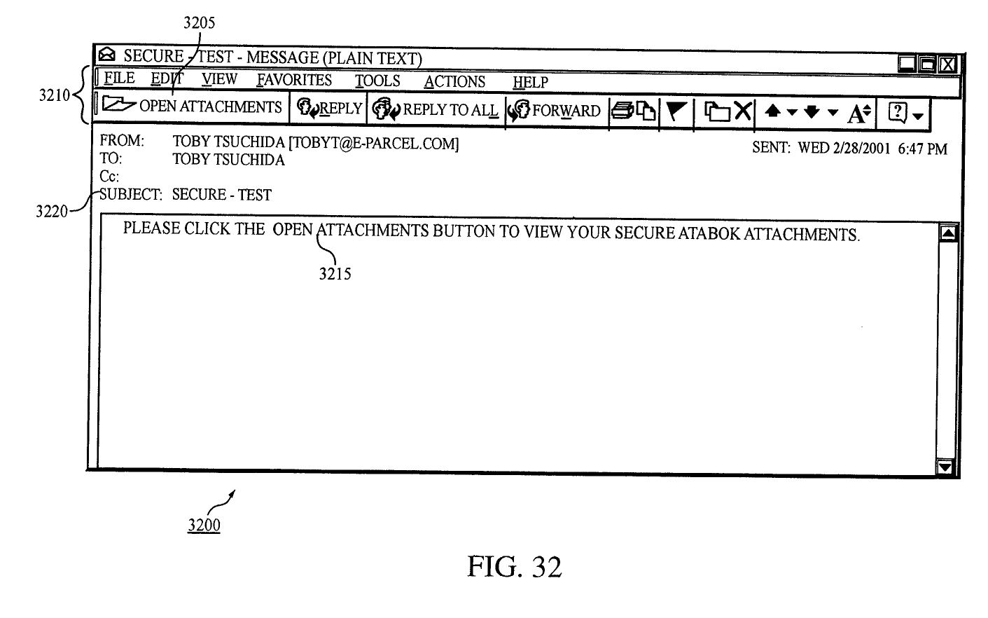

Moreover, the plug-in application may automatically add the word “Secure -” before the sender-specified text in Subject line 3130 (also see the Subject line 3220 of FIG. 32). For example, if the sender enters “Meeting notes May 2, 2001” in the subject line of the outgoing message, the recipient will receive the message, but the subject line 3130 will read “Secure- Meeting notes May 2, 2001”.

Once the recipient opens the message (e.g., clicks on the particular message listing 3115 or accesses the message using other techniques such as, for example, selecting/highlighting the particular message listing 3115 and depressing the “Enter” key on the user's keyboard), a message window 3200 will appear, as shown in FIG. 32. The electronic message, whether simple text or, for example, multimedia electronic content, may be hidden from the recipient's view and packaged in the form of attachments, which can be opened by the recipient. Accordingly, the recipient's message window 3200 can include, for example, an “Open Attachments” button 3205 in the toolbar 3210, and a message 3215 instructing the recipient to access the contents of the message by clicking the “Open Attachments” button 3205. Additionally, the recipient's message window 3200 can include, for example, an “Upgrade/Update” button in the toolbar 3210 for requesting from the sending system 110 any upgraded/updated versions of the digital content that may exist.

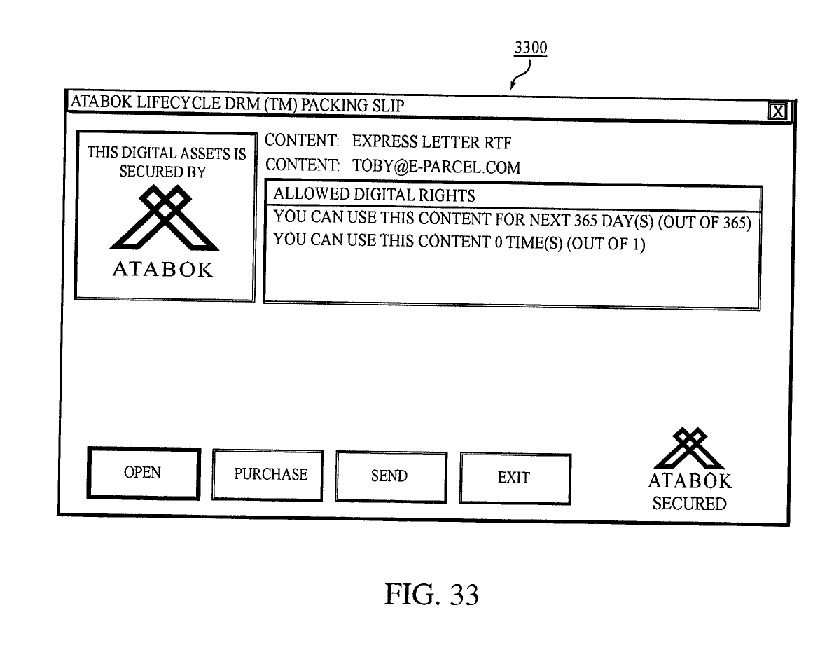

As shown in FIG. 33, when the recipient opens the attachments of the electronic message, a packing slip popup window 3300 may appear. The packing slip popup window 3300 can detail the rights in the digital asset, such as, for example, how long the digital content can be used, how many times the digital content can be used, and how the digital content may be manipulated. Further, the packing slip popup window 3300 may allow the recipient to open (e.g., view/manipulate) the digital asset, to purchase additional rights to manipulate the digital asset, and to send the digital asset to other recipients.

In the implementation described above, once the digital content is opened, and the receiving procedure described above is finished, the plug-in application 2400 may display the digital content on the display of the receiving system 115. Depending on the options chosen by the sender during the sending process, when the rights to manipulate the digital content expire, the digital content may no longer be manipulated by the recipient. To evidence the expiration of the digital rights, the “autoshred” feature may cause the screen display of the digital content to appear as if the screen is, for example, visually “shredding” or “melting” once the recipient has been alerted, for example, by a popup message, to the expiration of the digital rights.

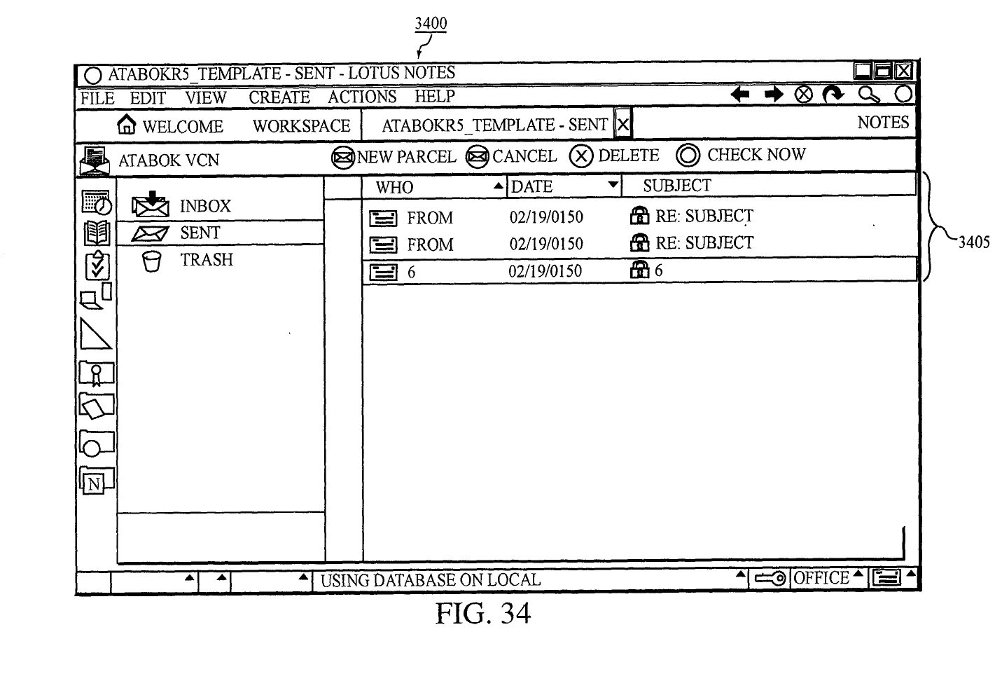

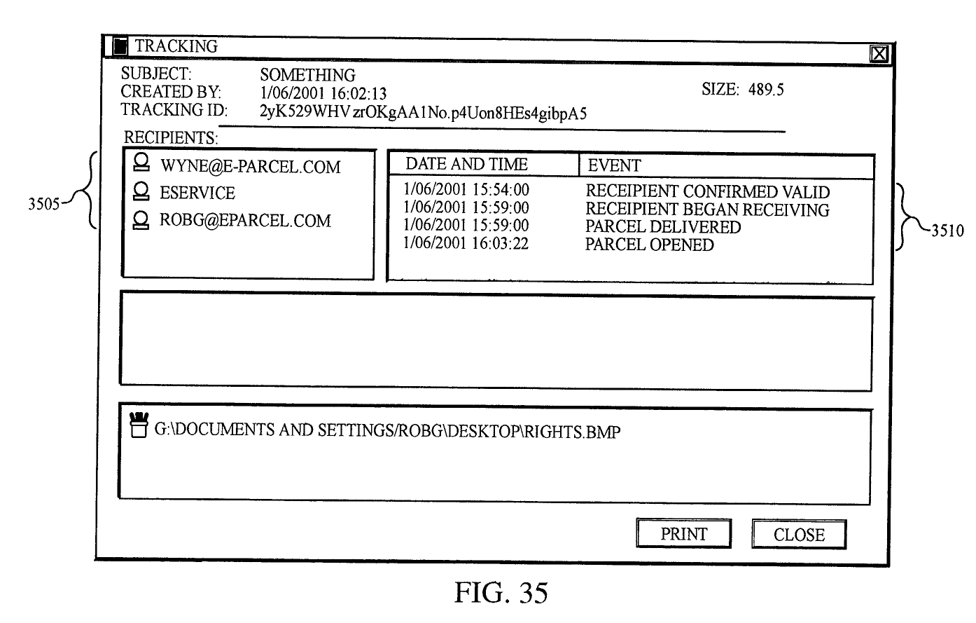

Another feature that may be implemented is a tracking feature, as discussed above. Referring to FIGS. 27, 34 and 35, when a sender accesses the separate plug-in application “outbox” folder 2715, an “outbox” window 3400 may appear. The window 3400 displays the items 3405 sent by the sender using the plug-in application 2400. If a sender selects an item 3405 listed in the “outbox” window 3400, a tracking popup window 3500 may appear. The tracking popup window 3500 may list details regarding recipients 3505 and sending status 3510. Details of the sending status 3510 may include information such as when/how the digital content was received, viewed, destroyed (e.g., shredded), and if the digital content was manipulated in any other way and by whom. Further, the sending status 3510 may include details such as, for example, date and time the delivery of the digital content parcel commenced and finished, when/if the recipient was confirmed as a valid registered recipient, and when the digital content parcel was opened.

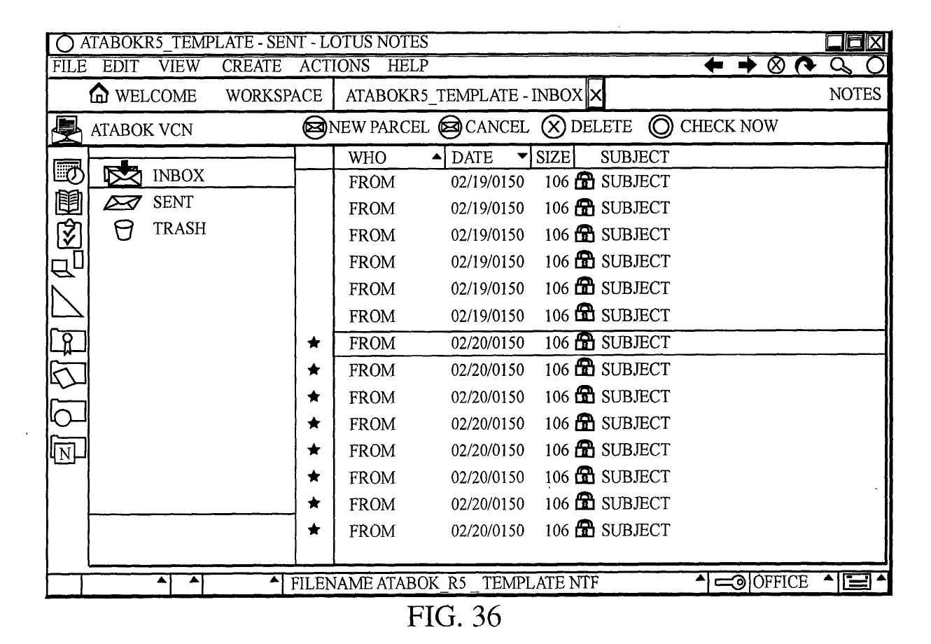

Many features of several implementations of the plug-in application have been described above using screenshots of Microsoft® Outlook® and Lotus® Notes as the existing software applications 2405. Similar graphical user interface features may be included in other types of existing software applications 2405 with which the plug-in application 2400 can be integrated. Additionally, various features of several implementations of graphical user interface features in FIGS. 36-39 are discussed above with respect to Microsoft® Outlook®, but are shown in FIGS. 36-39 as being implemented in Lotus® Notes.

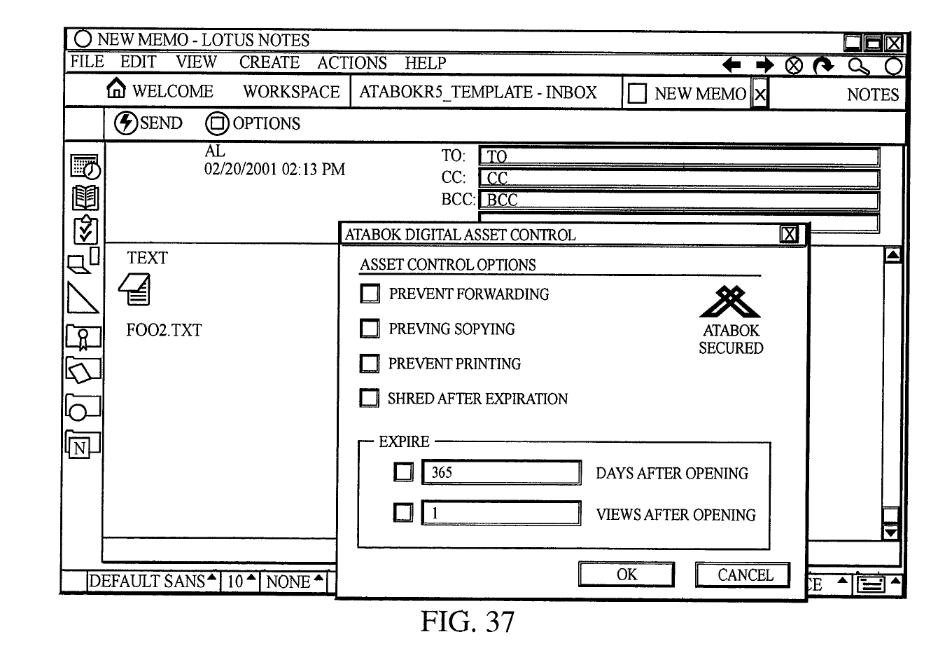

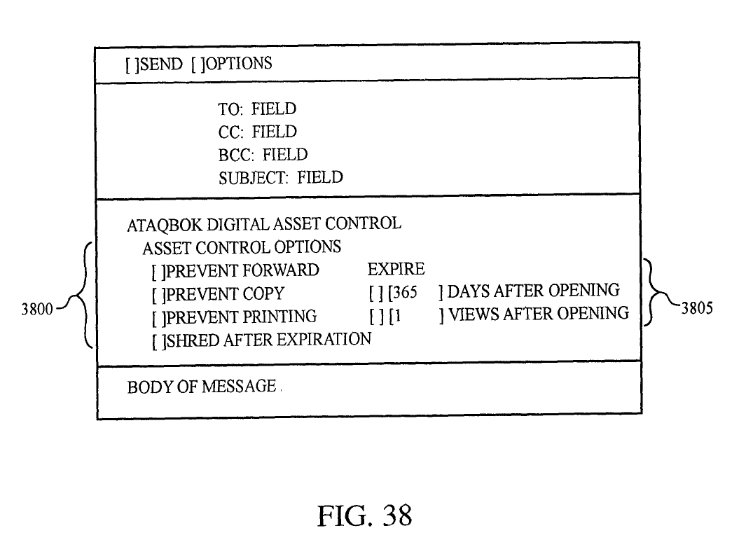

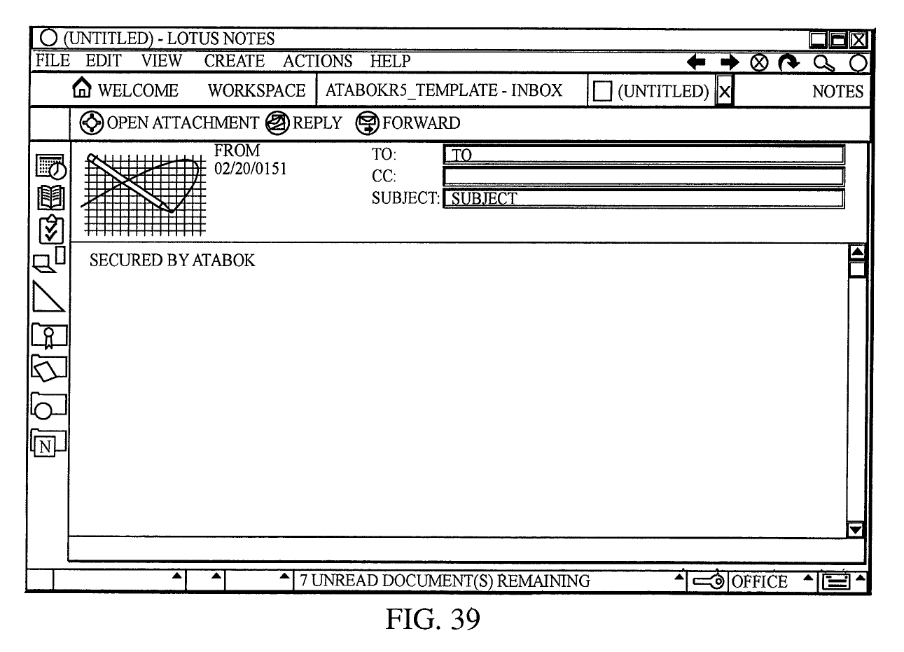

For example, FIG. 36 corresponds to the “Inbox” normal main screen graphical user interface of Microsoft® Outlook® depicted in FIG. 27. Likewise, FIG. 37 corresponds to the digital asset control window of Microsoft® Outlook® depicted in FIG. 28. Moreover, FIG. 38 illustrates another implementation of the digital asset control window, wherein the options 3800 and input areas 3805 are found in, for example, the message creation window 2615 of FIG. 26. Also, FIG. 39 corresponds to the (received) message window of Microsoft® Outlook® depicted in FIG. 32.

Other implementations are within the scope of the following claims. For example, the systems and techniques described above may be implemented as one or more computer-readable software programs embodied on or in one or more articles of manufacture. The article of manufacture can be, for example, any one or combination of a floppy disk, a hard disk, hard-disk drive, a CD-ROM, a DVD-ROM, a flash memory card, an EEPROM, an EPROM, a PROM, a RAM, a ROM, or a magnetic tape. In general, any standard or proprietary, programming or interpretive language can be used to produce the computer-readable software programs. Examples of such languages include C, C++, Pascal, JAVA, BASIC, Visual Basic, LISP, PERL, and PROLOG. The software programs may be stored on or in one or more articles of manufacture as source code, object code, interpretive code, or executable code.

What is claimed is:

1. A method of modifying an electronic mail system to produce a secure delivery system, the method comprising:
modifying a user interface of the electronic mail system to present a secure delivery icon, the secure delivery icon being presented in addition to a normal delivery icon of the electronic mail system; and
causing the electronic mail system to initiate a secure delivery in response to actuation of the secure delivery icon, the secure delivery using a delivery protocol different from a protocol provided by the electronic mail system.

2. The method of claim 1 further comprising, after actuation of the secure delivery icon, inserting in a subject line associated with a message delivered using secure delivery an indication that the message was delivered using secure delivery.

3. The method of claim 1 further comprising presenting with a message delivered using secure delivery an icon indicating that the message was delivered using secure delivery.

4. The method of claim 3 wherein presenting an icon indicating that the message was delivered using secure delivery comprises superimposing a padlock icon on a portion of a normal message icon used by the electronic mail system.

5. The method of claim 1 wherein causing the electronic mail system to initiate a secure delivery comprises:
encrypting, at a sending system, digital content to produce encrypted digital content; and
transmitting the encrypted digital content over a secured communication path from the sending system to a receiving system.

6. The method of claim 5 wherein causing the electronic mail system to initiate a secure delivery further comprises compressing the encrypted digital content before transmitting the encrypted digital content.

7. The method of claim 1 further comprising preventing a preview pane of the electronic mail system at a receiving system from displaying any portion of digital content sent by the secure delivery.

8. The method of claim 7 further comprising displaying a security message alerting a recipient that the digital content sent by the secure delivery cannot be displayed in the preview pane and must instead be opened to be viewed.

9. The method of claim 1 further comprising modifying the user interface of the electronic mail system to further present an autoshred icon before or during the secure delivery.

10. The method of claim 9 wherein actuation at a sending side of the autoshred icon causes digital content sent by the secure delivery to be erased from a receiving system after a recipient has manipulated the digital content a controllable number of times.

11. The method of claim 10 wherein actuation of the autoshred icon further causes a graphical manipulation of a screen display of the digital content, such that the screen display appears to shred and disappear.

12. The method of claim 1 further comprising displaying a popup window at the receiving side describing how digital content sent by the secure delivery may be manipulated by a recipient once a recipient chooses to open the digital content.

13. The method of claim 1 wherein modifying a user interface of the electronic mail system to present a secure delivery icon provides a sender with a clear visual option to send digital content using a secure digital rights management delivery system or a normal unsecure system for delivery.

14. The method of claim 1 further comprising modifying the user interface of the electronic mail system to further present a recall icon before or during the secure delivery.

15. The method of claim 14 wherein actuation at a sending side of the recall icon causes digital content sent by the secure delivery to be automatically recalled and erased from a receiving system.

16. The method of claim 14 wherein actuation at a sending side of the recall icon prevents digital content sent by the secure delivery from being manipulated in any way.

17. The method of claim 1 further comprising modifying the user interface of the electronic mail system to further present a prevent chain letter icon before or during the secure delivery.

18. The method of claim 17 wherein actuation at a sending side of the prevent chain letter icon prevents digital content sent by the secure delivery from being forwarded to any other receiving system.

19. The method of claim 1 further comprising modifying the user interface of the electronic mail system to further present a prevent copy icon before or during the secure delivery.

20. The method of claim 19 wherein actuation at a sending side of the prevent copy icon prevents digital content sent by the secure delivery from being copied in any manner.

21. The method of claim 1 further comprising modifying the user interface of the electronic mail system to further present tracking options before or during the secure delivery.

22. The method of claim 21 wherein actuation at a sending side of the tracking options causes a tracking of usage of digital content sent by the secure delivery to a receiving system.

23. The method of claim 21 wherein tracking of usage comprises gathering information about at least one of a time the digital content was received, a time the digital content was viewed, if the digital content was viewed, and how the digital content was manipulated.

24. The method of claim 1 wherein the electronic mail system is Microsoft® Outlook®.

25. The method of claim 1 wherein the electronic mail system is Lotus® Notes.

26. A computer program stored on a computer readable medium or a propagated signal for modifying an electronic mail system to produce a secure delivery system, the computer program comprising instructions for causing a processor to:
modify a user interface of the electronic mail system to present a secure delivery icon, the secure delivery icon being presented in addition to a normal delivery icon of the electronic mail system; and
cause the electronic mail system to initiate a secure delivery in response to actuation of the secure delivery icon, the secure delivery using a delivery protocol different from a protocol provided by the electronic mail system.

27. The computer program of claim 26 further comprising instructions for causing the processor to respond to actuation of the secure delivery icon by inserting in a subject line associated with a message delivered using secure delivery an indication that the message was delivered using secure delivery.

28. The computer program of claim 26 further comprising instructions for causing the processor to present with a message delivered using secure delivery an icon indicating that the message was delivered using secure delivery.

29. The computer program of claim 26 wherein instructions for causing the electronic mail system to initiate a secure delivery comprise instructions for causing the processor to:
encrypt digital content to produce encrypted digital content; and
transmit the encrypted digital content over a secured communication path to a receiving system.

30. The computer program of claim 29 wherein instructions for causing the electronic mail system to initiate a secure delivery further comprise instructions for causing the processor to compress the encrypted digital content before transmitting the encrypted digital content.

31. The computer program of claim 26 wherein instructions for causing the processor to modify a user interface of the electronic mail system to present a secure delivery icon include instructions for causing the processor to provide a sender with a clear visual option to send digital content using a secure digital rights management delivery system or a normal unsecure system for delivery.
